(19) United States
(12) Patent Application Publication
(10) Pub. No.: US 2024/0397381 A1
(43) Pub. Date: Nov. 28, 2024

(54) METHODS FOR THE COMMUNICATION OF ADAPTIVE TRAFFIC STEERING

(71) Applicant: InterDigital Patent Holdings, Inc., Wilmington, DE (US)

(72) Inventors: Quang LY, Conshohocken, PA (US); Michael STARSINIC, Conshohocken, PA (US); Catalina MLADIN, Conshohocken, PA (US); Hongkun LI, Malvern, PA (US); Jiwan NINGLEKHU, Royersford, PA (US); Pascal ADJAKPLE, Melville, NY (US)

(21) Appl. No.: 18/783,380

(22) Filed: Jul. 24, 2024

Related U.S. Application Data
(63) Continuation of application No. 18/251,062, filed on Apr. 28, 2023.
(60) Provisional application No. 63/183,657, filed on May 4, 2021.
(60) Provisional application No. 63/108,957, filed on Nov. 3, 2020.

(51) Int. Cl. H04W 28/086; H04W 28/02

(52) U.S. Cl. CPC H04W 28/0865; H04W 28/0215

(57) ABSTRACT

A user equipment (UE) and a network may communicate to dynamically adapt the steering of traffic over both 3GPP and non-3GPP accesses for uplink, downlink, or both. For example, a UE may request from the network the ability to dynamically adapt uplink traffic and the network may also apply the same traffic adaptation on downlink traffic. The UE and network may communicate dynamic traffic adaptation using traffic steering rules, e.g., via control plane NAS protocol, and with user plane signalling, e.g., via user plane PMF protocol.

### CROSS-REFERENCE TO RELATED APPLICATIONS

This application is a continuation of U.S. application Ser. No. 18/251,062, filed Apr. 28, 2023, which is a National Phase entry under 35 U.S.C. § 371 of International Application No. PCT/US2021/057818, filed on Nov. 23, 2021, which claims the benefit of U.S. Provisional Patent Application No. 63/183,657, filed May 4, 2021, and U.S. Provisional Patent Application No. 63/108,957, filed Nov. 3, 2020, the contents of each are hereby incorporated by reference herein.

### BACKGROUND

The 3GPP Release 16 Access Traffic Steering, Switching, and Splitting (ATSSS) feature provides a UE the ability to steer, switch, and split data traffic over both 3GPP and non-3GPP accesses. For background, see:
3GPP TS 23.501, System Architecture for the 5G System, Stage 2, V16.6.0 (2020-09);
3GPP TS 23.502, Procedures for the 5G System, Stage 2, V16.6.0 (2020-09);
3GPP TS 23.503, Policy and Charging Control Framework for the 5G System, Stage 2, V16.6.0 (2020-09);
3GPP SP-200095, Study on Access Traffic Steering, Switch, and Splitting support in the 5G system architecture Phase 2, SP #87E (2020-03);
3GPP TR 23.700-93, Study on Access Traffic Steering, Switch and Splitting support in the 5G system architecture Phase 2, V0.3.0 (2020-09);
3GPP TS 24.501, Non-Access-Stratum (NAS) protocol for Evolved Packet System (EPS), Stage 3, V16.6.0 (2020-09);
3GPP TS 24.193, Access Traffic Steering, Switching and Splitting (ATSSS), Stage 3, V16.1.0 (2020-09);
3GPP TS 37.324, Service Data Adaptation Protocol (SDAP) specification, V16.2.0 (2020-09); and
3GPP TS 38.415, PDU Session User Plane Protocol, V16.2.0 (2020-09).

### SUMMARY

A user equipment (UE) and a network may communicate to dynamically adapt the steering of traffic over both 3GPP and non-3GPP accesses for uplink, downlink, or both. For example, a UE may request from the network the ability to dynamically adapt uplink traffic. The network may apply the same traffic adaptation on downlink traffic. The UE and network may communicate dynamic traffic steering adaptation using control plane signalling, e.g., via NAS protocol, and user plane signalling, e.g., via PMF protocol.

For example, a UE may send a Multi-Access Protocol Data Unit (MA PDU) session request to a network Session Management Function (SMF) for a session to send traffic over a 3GPP access and a non-3GPP access. The UE may then receive one or more traffic steering rules from the SMF, and an indicator that dynamic traffic adaptation is enabled for the MA PDU session. The UE may then determine, based on internal conditions and the indicator, to change how much traffic of the session is sent over the 3GPP access and/or non-3GPP access. The UE may further send to a User Plane Function (UPF) that adapts traffic between 3GPP access and non-3GPP access a request via user plane signalling to change how much traffic of the session is sent over the 3GPP access and/or non-3GPP access.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 is a block diagram of an example non-roaming 5G system architecture in reference point representation.

FIG. 2 is a block diagram of an example local breakout architecture for Access Traffic Steering, Switching, and Splitting (ATSSS) support for roaming and non-roaming.

FIG. 3 is a call flow of an example multi-access (MA) Protocol Data Unit (PDU) procedure enhancements for user equipment (UE) request of adaptive traffic steering.

FIG. 4 illustrates example data elements for traffic steering adaptations enhancements to ATSSS rules.

FIG. 5 illustrates example data elements for enhancements to Service Data Application Protocol (SDAP) header.

FIG. 6 illustrates example data elements for enhancements to UL PDU Session Information message.

FIG. 7 illustrates example data elements for enhancements to Measurement Assistance Information (MAI).

FIG. 8 illustrates example data elements definitions for Threshold Value information.

FIG. 9 is a call flow of an example procedure for performance measurements exceeding threshold value error condition handling.

FIG. 10 illustrates an example graphical user interface (GUI).

FIG. 11A illustrates an example communications system.

FIGS. 11B, 11C, and 11D are system diagrams of example RANs and core networks.

FIG. 11E illustrates another example communications system.

FIG. 11F is a block diagram of an example apparatus or device, such as a WTRU.

FIG. 11G is a block diagram of an exemplary computing system.

### DETAILED DESCRIPTION

Table 22 of the appendix describes many of the acronyms used herein.

### 5G System Architecture

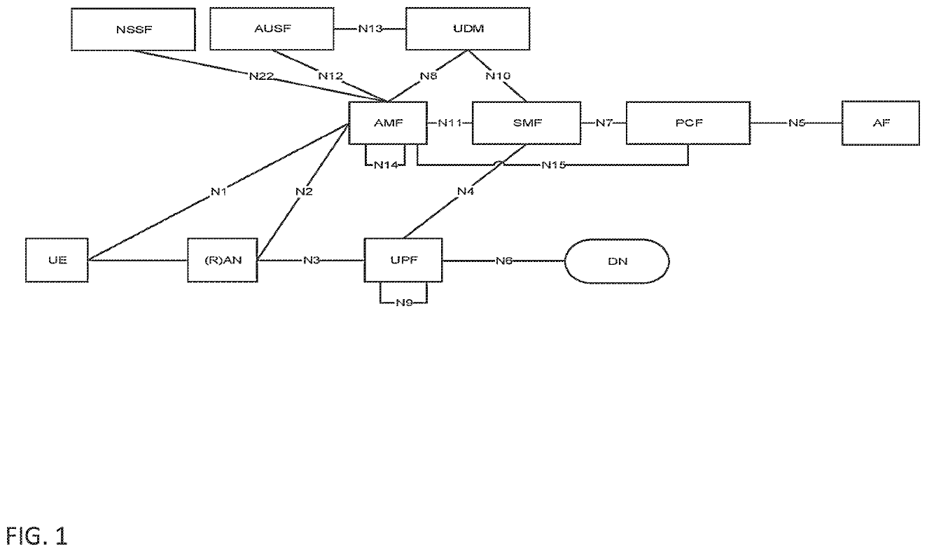

FIG. 1 shows the 3GPP 5G non-roaming system architecture where various entities interact with each other over the indicated reference points. A User Equipment (UE) may communicate with a Core Network (CN) to establish control signaling and enable the UE to use services from the CN. Examples of control signaling functions are registration, connection and mobility management, authentication and authorization, session management, etc. See 3GPP TS 23.501, System Architecture for the 5G System; Stage 2, V16.6.0 (2020-09).

The following descriptions highlight some of the Network Functions (NFs) from FIG. 1 that are involved with control signalling:

Access and Mobility Function (AMF): The UE sends an N1 message through the RAN node to the AMF to perform many control plane signaling operations such as registration, connection management, mobility management, access authentication and authorization, etc.

Session Management Function (SMF): The SMF is responsible for session management involved with establishing PDU sessions to allow UEs to send data to Data Networks (DNs) such as the internet or to an application server and other session management related functions.

Policy and Control Function (PCF): The PCF provides the policy framework that governs network behavior, accesses subscription information to make policy decisions, etc.

Authentication Server Function (AUSF): The AUSF supports authentication of UEs for 3GPP and untrusted non-3GPP accesses.

Unified Data Management (UDM): The UDM supports generation of 3GPP AKA Authentication Credentials, user identification handling, subscription management, etc.

Network Slice Selection Function (NSSF): The NSSF is involved with aspects of network slice management such as selection of network slice instances for UEs, management of NSSAIs, etc.

Radio Access Network (RAN): The RAN node offers communication access from the UE to the core network for both control plane and user plane communications.

### Access Traffic Steering, Switching, Splitting

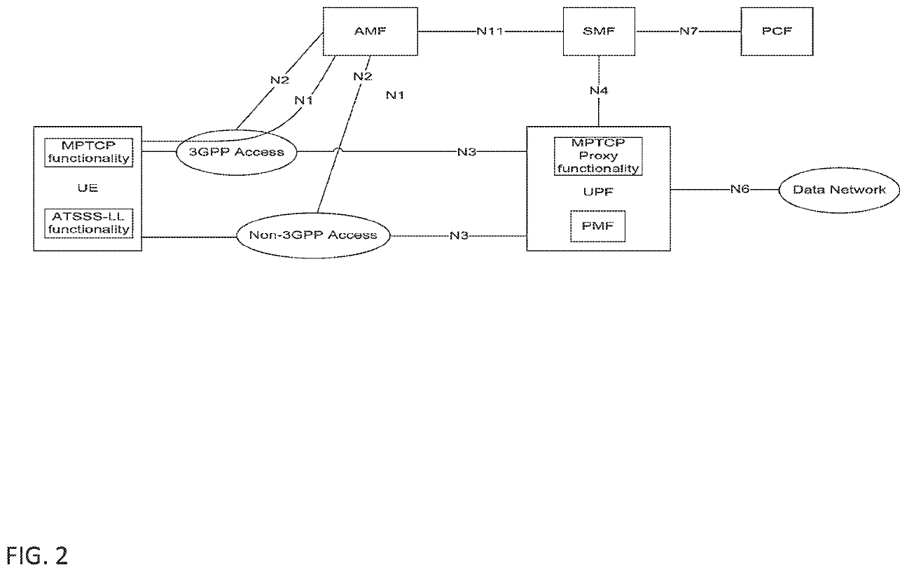

In Release 16, 3GPP added the Access Traffic Steering, Switching, Splitting (ATSSS) feature to the 5G system. This feature allows data traffic between the UE and the core network to be routed over cellular or non-cellular (e.g., such as WiFi networks) access networks or over both access networks at the same time. FIG. 2 shows the architectural diagram of the ATSSS feature incorporated with the 5GS. The 3GPP access represents the cellular access network while the non-3GPP access represents WiFi or similar access networks.

In order to utilize the ATSSS feature, a UE creates a Multi-Access (MA) PDU session with both the 3GPP and non-3GPP access networks and the core network returns ATSSS rules to direct the UE on how to route uplink traffic. Within the ATSSS rules are steering modes that indicates how the UE is to steer traffic. The following steering modes are currently defined for Release 16 and copied directly from 3GPP TS 23.501 for convenience:
Active-Standby: It is used to steer a SDF on one access (the Active access), when this access is available, and to switch the SDF to the available other access (the Standby access), when Active access becomes unavailable. When the Active access becomes available again, the SDF is switched back to this access. If the Standby access is not defined, then the SDF is only allowed on the Active access and cannot be transferred on another access.
Smallest Delay: It is used to steer a SDF to the access that is determined to have the smallest Round-Trip Time (RTT). As defined in clause 5.32.5, measurements may be obtained by the UE and UPF to determine the RTT over 3GPP access and over non-3GPP access. In addition, if one access becomes unavailable, all SDF traffic is switched to the other available access, if allowed by the PCC rules (as specified in clause 5.32.4).
Load-Balancing: It is used to split a SDF across both accesses if both accesses are available. It contains the percentage of the SDF traffic that should be sent over 3GPP access and over non-3GPP access. Load-Balancing is only applicable to non-GBR QoS flow. In addition, if one access becomes unavailable, all SDF traffic is switched to the other available access, as if the percentage of the SDF traffic transported via the available access was 100%.
Priority-based: It is used to steer all the traffic of an SDF to the high priority access, until this access is determined to be congested. In this case, the traffic of the SDF is sent also to the low priority access, e.g., the SDF traffic is split over the two accesses. In addition, when the high priority access becomes unavailable, all SDF traffic is switched to the low priority access. How UE and UPF determine when a congestion occurs on an access is implementation dependent.

In Release 17, a new study item FS_ATSSS_Ph2 was approved to determine if additional steering modes could be added to enhance the ATSSS feature. Sec 3GPP SP-200095, Study on Access Traffic Steering, Switch, and Splitting support in the 5G system architecture Phase 2; SP #87E (2020-03). A technical report TR 23.700-93 was created to capture potential solutions to address adding more steering modes. See 3GPP TR 23.700-93, Study on Access Traffic Steering, Switch and Splitting support in the 5G system architecture Phase 2; V0.3.0 (2020-09). A common theme of the proposed solutions provides more autonomy for the UE or the network to make steering decisions based on UE or network conditions. For example, a UE can adapt uplink traffic steering based on new performance measurements such as packet loss ratio, jitter measurement, RTT difference, etc. Furthermore, a UE may also factor in its own internal state, such as battery level and power consumption, when making uplink traffic steering decisions.

### EXAMPLE USE CASES

A user launches a gaming app on a smartphone and is presented with a configuration screen for the online session. There is an option to enable the app to dynamically adapt traffic steering as necessary to maintain a certain level of service. The application requires this capability to ensure the gaming session operates smoothly and can provide the appropriate frame rates to enhance the user experience. Without the capability, the app may drop frames during game action and may not render graphics as smoothly. In addition, the user may be mobile, e.g., traveling on a train or bus, and the mobility may affect cellular or Wi-Fi coverage. To maintain the required bandwidth, the application can dynamically adapt to changes in service coverage (e.g., cellular and Wi-Fi coverage) as necessary.

Another example use case is that of a production manager at a factory who has a daily, hour long commute on a train that offers Wi-Fi service. The manager needs to communicate with his team during the commute to address any issues that may have arisen during the morning shift change as well as prepare for the work of the upcoming shift. The manager may engage with his team over video conferencing or review schematic drawings during the meeting. As a result, the manager's laptop is equipped with cellular access to allow for the selection, switching, and splitting of user traffic between the cellular and Wi-Fi networks. The train route travels through physical obstacles such as mountains, hills, buildings, and trees that impact cellular coverage for portions of the commute. Similarly, the Wi-Fi service suffers degradation when there is an increase in users within the train. The manager's laptop and his service provider both support the ATSSS feature to allow for the laptop to steer data traffic over both 3GPP and non-3GPP (e.g., Wi-Fi) access networks.

### EXAMPLE CHALLENGES

The ATSSS steering modes defined in Release 16 are fairly static in nature. In other words, the ability of the UE to steer data traffic is mostly dependent on the availability of an access—the UE switches to another access network whenever the other access network is not available. Both the Active-standby and Smallest Delay steering modes do not offer the ability to split traffic between 3GPP and non-3GPP accesses. The Load-Balancing and Priority-based steering modes do offer a certain level of traffic splitting functionality but only in a limited fashion. For example, the Load-Balancing steering mode is limited to a fixed percentage that is determined by the network and cannot be changed once the MA PDU session is established while the Priority-based steering mode allows splitting only if the higher priority access is congested; without congestion, traffic is steered to the higher priority access. It is also not clear at what level of congestion would traffic splitting be enabled. Once the steering mode is determined and ATSSS rules have been created in Release 16, the UE is limited to using the selected steering mode and the generated ATSSS rules.

In Release 17, the FS_ATSSS_Ph2 study identified new steering modes that offer more dynamic traffic steering capability for the UE and for the UPF, such as the Autonomous steering mode with advanced PMF or the UE assisted traffic steering mode. These steering modes allow the UE or the network to make traffic steering and splitting decisions dynamically based on UE or network conditions. While these newly proposed steering modes offer more dynamic traffic steering capabilities, they also introduce an issue with how the core network is informed of the UE's traffic steering decisions. The cellular system was designed to ensure that both the UE and the core network communicate to each other using well defined protocols to ensure the system works optimally. Allowing the UE to dynamically make traffic steering decisions autonomously without communicating the traffic steering adaptations to the core network may cause the system to operate sub-optimally. As an example, the UE may adapt traffic steering without knowledge of whether the cellular access network is overloaded or not.

Associated with making adaptive traffic steering decisions is the need to perform measurements such as RTT, packet loss rate, etc. indicating the connection quality of each access. Messages or data packets are exchanged between the UE and the UPF and measurements are made from those exchanges. Then traffic adaptation may be made accordingly. The configuration of the exchange of these performance measurements may need to be further clarified.

Adaptive traffic steering decisions can be made based on measurements. The measurements may be made in the UE and UPF. The measurements may be indicative of the quality of each access. The UE and UPF may exchange messages and the UE and UPF may perform measurements on those messages in order to determine the connection quality of each access. A problem that will be addressed in this paper is how the UE and UPF are configured to exchange these messages such that measurements can be properly performed. The UE and UPF configuration should take into the account the types of messages that need to be sent, the frequency at which they should be sent, etc.

In Release 17, threshold value was also introduced to assist with the determination of access quality. If a measurement exceeds the threshold value on an access, then the UE or UPF may steer traffic towards the other access or split the traffic such that the percentage weighting is larger on the other access. The assumption is that the measurement of the other access is below the threshold value. However, if the measurement of the other access also exceeds the threshold, then a potential error condition exists in which there is no definitive traffic steering decision that could be made. Solutions will also be proposed to address this condition.

### EXAMPLE SOLUTIONS

Another use case that may benefit from adaptive traffic steering capabilities is AR/VR applications, which requires high data bandwidth to enable an immersive experience for the user. Similar to the online gaming application, the AR/VR application may prompt the user to enable the ability of the application to request the capability of adapting traffic steering, as necessary. Upon consent, the application may request from the network the ability to adapt traffic steering. Alternatively, the application may require this consent when the application was installed and automatically request for adapting traffic steering when establishing an MA PDU session with the network.

Thus far, the focus has been on the UE requesting adaptation of traffic steering based on the needs of the UE. However, the network may also adapt traffic steering due to overloaded conditions the network is experiencing. For example, the network may request UEs to adapt traffic steering towards an access to lessen the burden of traffic on the other access. This may be triggered by measurements provide by the UE or obtained by the network, analytics generated by NWDAF, or via a command from the OAM system. Overloading may refer to network resources, e.g., in RAN nodes or UPF network functions of the user plane, or it may refer to overloading from a network slice perspective where the number of PDU sessions are approaching the capacity of the network slice. Traffic adaptation may also be requested by the network for network function migration and/or orchestration purposes or as part of network maintenance.

Dynamic traffic steering may be requested by the UE or the network in both UL and DL directions. The UE may request traffic adaptation not only for UL only traffic but also for DL only traffic and for both UL and DL traffic. Likewise, the network may request traffic adaptation for UL only traffic as well as for DL only traffic and for both UL and DL traffic. In the UE case, the UE may want to request the network to adapt DL traffic towards the non-3GPP access, e.g., to help the UE preserve battery level or the UE is receiving higher data rates on the non-3GPP access. The UE may also request DL traffic adaptation to mirror the adaptation performed on UL traffic, e.g., to have DL traffic use the same steering mode and range of steering percentages as UL traffic. Similarly, the network may want the UE to adapt UL traffic onto 3GPP access due to overloading conditions on the non-3GPP access path or to have the UE mirror UL traffic to that of DL traffic.

As the above use cases highlight, dynamic traffic steering adaptations may be beneficial to ensure a certain quality of service is provided to applications running on UEs. However, traffic steering adaptations should be performed in coordination with the network in order for the system to operate as efficiently as possible. In addition, the network may also request traffic adaptation due to overloading experienced by the network. Therefore, it is beneficial that traffic steering adaptations be communicated between the UE and the network to ensure there are no adverse impacts resulting from the adaptations. As a result, it is proposed to add enhancements to the 5G system to allow the UE to communicate its preference for adaptive traffic steering functionality to the network and to define mechanisms for the UE to provide such communication. Likewise, the mechanisms may also be utilized by the network to communicate traffic adaptation to the UE whenever there is a need for this communication.

Note that while the descriptions hereinafter are focused on the UE's role in traffic adaptation, the UPF is also able to participate in the traffic adaptation. Information provided to the UE in adaptation or ATSSS rules may also be provided to the UPF in N4 (or MAR) rules. Similarly, while the UE performs traffic adaptation for UL traffic, the UPF performs traffic adaptation for DL traffic.

### UE Request for Adaptive Traffic Steering

The mechanism for the UE communicating to the core network of the UE's interest in utilizing adaptive traffic steering may be signaled as part of the MA PDU session procedures. The mechanism can be divided into two main approaches: 1) the UE may use an adaptive steering operational mode, in conjunction with existing and future steering modes defined for ATSSS; and 2) the UE may request “adaptive” steering mode(s) from the network in which the UE is able to dynamically adapt uplink and/or downlink traffic steering based on the steering mode(s). When the UE indicates to the network that it supports adaptive steering operation mode, the UE may additionally indicate which steering modes it supports.

In the former approach, the UE includes an adaptive steering capability indication in addition to selecting a steering mode such as Load Balancing, or one of the proposed steering modes in Release 17, or a future steering mode. This approach builds upon existing and future steering modes and allows the UE the freedom to dynamically adapt traffic steering for any steering mode. In response, the network may provide adaptation rules the UE must follow in order to use the adaptive steering capability. The benefit of this approach is that the network is aware of the steering mode employed by the UE and hence network policies and other operational functions may be utilized as currently defined. In this approach, UE makes adaptation decisions based on the provisioned steering mode and on the rules and information provided by the network.

The latter approach may be deployed to simplify the selection of steering modes by having a UE request for adaptive steering capabilities from the network. The UE may request for an adaptive steering mode by providing an indication and other information (e.g., types of application or application ID, bandwidth requirements, mobility information, measurement information, etc.) to assist the network with choosing an appropriate steering mode or modes. In response, the network may select a steering mode that meets the criteria provided by the UE and the response may also include adaptation rules to inform the UE of the conditions traffic adaptation may be made. This approach may be triggered for certain applications that require adaptive traffic steering as described in the aforementioned use cases, such as online gaming and AR/VR applications. The adaptation of traffic steering may be required in these use cases in order to preserve a certain level of QoS and maintain an immersive experience for the user. The UE may provide information about the needs of these applications and let the network decide on the best use of traffic steering resources, such as the steering mode to employ, the adaptation rules for UE traffic adaptation, proper UPF selection with adaptive steering capabilities, etc. This approach relies on the network selecting the steering mode for the UE.

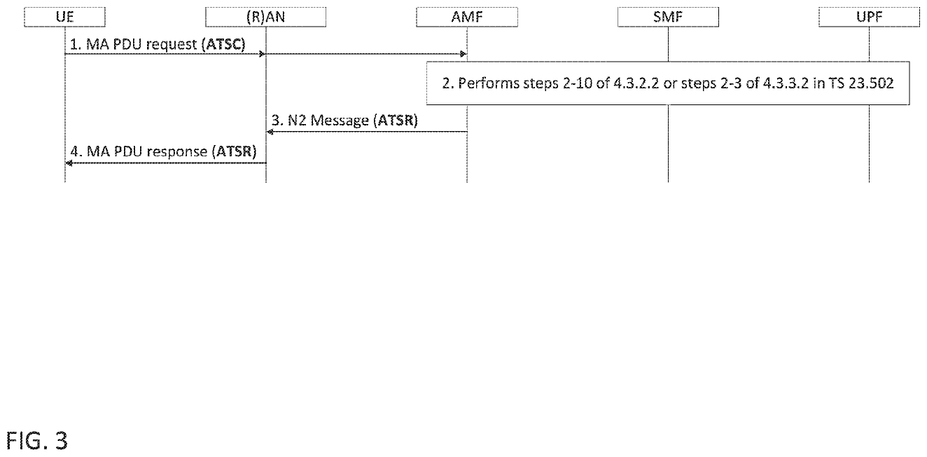

When the UE establishes or modifies an MA PDU session, the UE may include either an adaptive steering capability indication or an adaptive steering mode request indication to communicate to the network the request for adaptive traffic steering capability or adaptive steering mode(s) for the MA PDU session. FIG. 3 shows the general procedure of an MA PDU session request, whether for establishing an MA PDU session or for modifying an MA PDU session, and the information the UE may provide in the request, such as an Adaptative Traffic Steering Capability (ATSC) indication.

Step 1: A UE makes either an MA PDU session establishment or modification request and includes an Adaptive Traffic Steering Capability (ATSC) indication to notify the network that the UE has adaptive traffic steering capability and would like to enable adaptive traffic steering functionality for the MA PDU session. The ATSC indication may be included in addition to a steering mode which represent the fact that the UE can adapt data traffic while using the steering mode. Alternatively, ATSC indication may signify the UE's request from the network for adaptive traffic steering mode(s) if no steering mode is provided in the request. The UE may also include other information of the requirements and use of the MA PDU session to assist the network with granting the MA PDU session and allowing for adaptive traffic steering. The information may include the types of application or the application ID using this MA PDU session, the minimum bandwidth requirements, whether the UE will be mobile, the current signal strengths of 3GPP and non-3GPP access networks, identifiers of available non-3GPP networks (e.g., SSID), the steering modes that the UE is willing and able to support, the types of analytics and performance measurements the UE has access to, etc.

Step 2: The AMF forwards the message to the SMF and the SMF proceeds with the steps as outlined in TS 23.502 for the appropriate MA PDU session procedure. In addition to evaluating the request for creating an MA PDU session, the SMF may also check with the PCF (not shown in the figure) on whether to allow adaptive traffic steering for this MA PDU session. The SMF may also provide the information provided by the UE in step 1 to the PCF to assist the PCF in making the decision of whether to grant the adaptive traffic steering capability to the UE. If adaptive traffic steering is granted, the SMF may create adaptation rules for the UE to use when adapting data traffic. The SMF may also use the other information the UE provided in step 1 when generating the adaptation rules. The adaptation rules may be integrated into the ATSSS rules that are created for the MA PDU session or the adaptation rules may be separate from the ATSSS rules. Similarly, the adaptation rules may be integrated into the N4 rules created for the UPF or the adaptation rules may be separate.

Step 3: The SMF returns a response to the MA PDU request encapsulated in an N2 message and sent through the AMF to the RAN node. The response may include one or more Adaptive Traffic Steering Rules (ATSR) in which the UE must follow when adapting data traffic. In addition, or alternatively, the response may include an indication that the UE is allowed to dynamically adapt traffic steering for the MA PDU. The details of these rules will be provided hereinafter. As previously stated, the adaptive traffic steering rules may be incorporated into the ATSSS rules that are generated for the UE and into N4 rules generated for the UPF.

Step 4: The MA PDU response is sent to the UE. If the ATSC indication was used to request for an adaptive steering mode from the network, the SMF may return in the response a steering mode that allows for adapting data traffic. This steering mode may be a standalone steering mode, such as the autonomous steering mode proposed in the FS_ATSSS_Ph2 study or just an “adaptive” steering mode where the UE is allowed to adapt traffic steering. Alternatively, the SMF may return a list of steering modes from which the UE may select a way to adapt data traffic. The SMF may also include adaptive traffic steering rules or ATSSS rules provided in step 3 and the UE stores the rules internally for use when the UE wants to adapt data traffic. The rules will guide the UE on when to adapt traffic steering, what steering modes to use, the range in which traffic steering may be made, the duration in which traffic steering may be adapted, etc.

An alternative approach to the UE using the MA PDU session procedures to communicate to the network about the desire to use adaptive traffic steering functionality is to use the Registration procedures instead. The UE may, during initial registration procedure, include an adaptive traffic steering capability indication along with the ATSSS-LL or MPTCP capability indication to inform the core network that the UE is capable of adaptive traffic steering. The network may in turn provide the UE with URSP rules that allows the UE to request for enabling adaptive traffic steering capabilities or for using adaptive traffic steering modes. The URSP Route Selection Descriptor may be enhanced as shown in Table 1 of the Appendix where an adaptive traffic steering indication is added to signal that the UE may request adaptive traffic steering capability and/or adaptive traffic steering mode for the MA PDU session. Note that this indication may alternatively be added to the adaptation or ATSSS rules to indicate to the UE that the network is allowing the UE to dynamically adapt traffic steering. Alternatively, the adaptive traffic steering capability may be enumerated within the Access Type preference as “Multi-Access with adaptive traffic steering.” This enumeration is in addition to the existing “Multi-Access” access type preference to differentiate multi-access type with and without adaptive traffic steering capability.

Similarly, the adaptive traffic steering capability indication may be included in mobility registration update or periodic registration update procedures to enable the update of URSP rules as previously proposed. The UE may have incurred a mobility event in which the new capability is now required, e.g., a user attends a gaming fair or is enabling an AR/VR application as part of a tour. The updated URSP rules would allow the UE to establish new MA PDU sessions with the adaptive traffic steering capability required by these high bandwidth applications.

### Traffic Steering Adaptation Rules

In addition to granting the UE the permission to utilize adaptive traffic steering capabilities or adaptive steering modes, the network may also provide adaptive traffic steering rules the UE must follow when adapting traffic steering. These rules may place limitations on the extent traffic adaptation may be made, in which direction (e.g., UL or DL, or both) traffic adaptation may be made, the period in which traffic adaptation is enabled, the conditions upon which traffic adaptation may be triggered, the range in traffic splitting, etc. Table 2 of the Appendix shows examples of attributes that may be used when the network generates adaptive traffic steering rules.

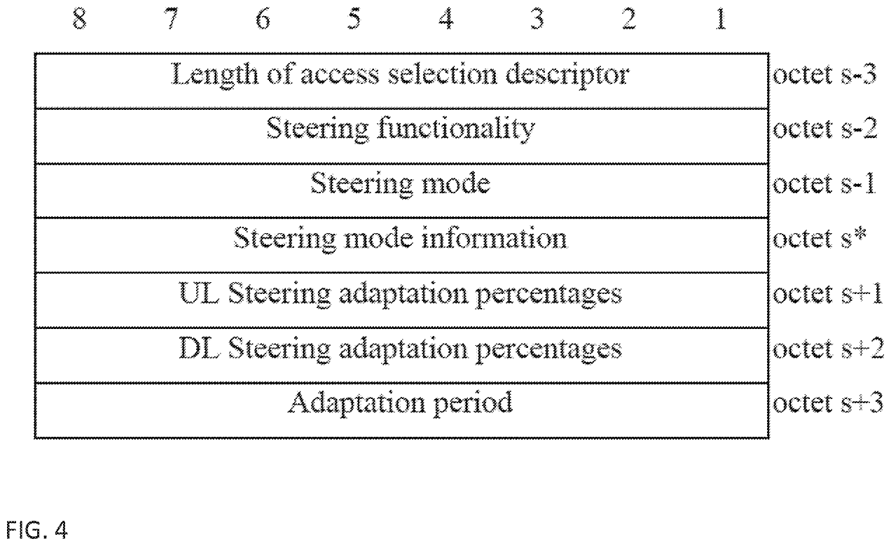

The network may return adaptation rules to the UE in response to granting an MA PDU session to the UE or in conjunction with URSP rules the network sends to the UE. When granting an MA PDU session, the network can incorporate the adaptation rules with the ATSSS and N4 rules the SMF generates for the UE and the UPF, respectively. In addition, the network may also send the UE adaptation rules in response to the UE communicating its desire to change the steering mode, e.g., such as in response to a service request or when the UE communicates to the network the UE would like to adapt traffic steering as described hereinafter. FIG. 4 shows an example enhancement to the ATSSS rule found in 3GPP TS 24.193, Access Traffic Steering, Switching and Splitting (ATSSS); Stage 3, V16.1.0 (2020-09). In this example, the UL Steering adaptation percentages, DL Steering adaptation percentages, and Adaptation period fields have been added to incorporate the adaptation rules into the ATSSS rules.

The enhancements shown in FIG. 4 provide additional information in the ATSSS rules for the UE to use when making traffic steering adaptation decisions. If adaptive traffic steering capability or adaptive steering mode is enabled, the Steering mode information may specify what triggers the adaptation. Once adaptation is triggered, the UL and DL Steering adaptation percentages may limit adaptations made by the UE and in which direction the adaptation may be made. Finally, the Adaptation period informs the UE how long traffic steering adaptation may be made.

Table 3 of the Appendix shows an example encoding of information elements proposed in FIG. 4 that may be found in ATSSS rules. For this example, the adaptive traffic steering is represented as a steering mode called adaptive based and a Reflective adaptation steering mode is proposed to mirror the adaptation performed according to the adaptation performed for UL or DL traffic. An alternative to defining the new adaptive traffic steering functionalities as steering modes would be to define the functionality as a mode of operation that is enabled in addition to other steering modes. For this alternative, a bit (e.g., bit 8) or bits may be defined that when the bit(s) is (are) set to “1”, the corresponding steering mode may be adapted in terms of percentage steering or based on adaptation performed for the specified direction. For example, if the Steering mode octet were set as “10000011”, the functionality that is specified would be that the Load balancing steering mode would be used and the UE would be able to adapt traffic steering based on other criteria, such as those defined in Table 3 of the Appendix. Similarly, if the steering mode octet were set as “10000100”, the UE would be able to adaptively steer traffic while using Priority based steering mode. The adaptation in both cases may be triggered based on communication, performance measurement exceeding certain thresholds, or triggered by analytics, as proposed in the Steering mode information octet. In the Reflective adaptation case, bits may be defined such that the adaptation performed in the UL direction may be requested to be performed on the DL direction as well. Thus, the steering mode employ, and the ranges of adaptation would be mirrored between the UL and DL data traffic.

As previously stated, the Steering mode information (octet s) may be defined such that when adaptive based steering functionality is selected, the conditions in which adaptive traffic steering may be triggered may be based on communication, performance measurements, or analytics. When adaptive traffic steering is triggered by communication, the UE or network may communicate the intention of enabling adaptive traffic steering via cither NAS or PMF protocol as described hereinafter. In addition, performance measurements and/or analytics may be triggered to enable adaptive traffic steering. In the case that performance measurements are used to make adaptation to traffic steering, the measurement type or identifier and threshold value may be defined per steering mode to assist the UE in making such adaptation. Then if the specified measurement value exceeds the specified threshold, traffic adaptation is triggered. When analytics is selected to enable traffic steering adaptation, the UE and/or UPF may utilize analytics generated by the NWDAF to make traffic adaptation decisions. If NWDAF analytics are not available, e.g., to the UE, the UE may use local analytics functionality and make the determination for adaptive traffic steering based on the results of the local analytics function.

Within the adaptation rules, maximum and minimum steering percentages may be specified to limit or constrain the extent in which adaptation may be made. The UE or the network would then use these percentages as limits to adapt data traffic accordingly. These percentages may be specified for both the UL and DL traffic steering independently. In addition, an adaptation period may be specified of the duration that traffic adaptation made be in effect. An alternative enumeration for the adaptation period shown in Table 3 of the Appendix may also include the measurement period for obtaining performance measurement that are used for adaptive traffic steering. The network may provide both measurement and adaptation periods to configure the UE and the UPF with specifying the frequency that performance measurement should be obtain and the frequency that adaptation may be made. The on-demand adaptation may provide an indication that the UE and UPF may adapt traffic as needed, e.g., based on connection quality of access or other criteria, such as low battery level or overloading conditions.

Note that adaptation rules may be provided by the UE or the network when requesting to enable adaptation or in response to granting adaptation capabilities. If the adaptation rules are provided during a request, the rule(s) in the request may signify the desired adaptation the requester would like to use during adaptation. When the adaptation rules are returned in a response to a request for enabling adaptation, the rule(s) in the response may signify that the granting of traffic adaptation are contingent on using the rules to adapt traffic. Adaptation rules may also be provided as part of pre-configuration of the UE, in a registration response, during UE configuration update procedure, or other NAS signaling where UE policies may be updated.

In addition to the adaptation or ATSSS rules provided to the UE, the SMF may also provide additional information in the N4 rules to the UPF. Table 4 of the Appendix shows example enhancements to the MAR rule table from 3GPP TS 23.501 sent in the N4 rules that the SMF may provide to the UPF in support of adaptive traffic steering functionality. The enhancements reflect similar enhancement that are provided to the UE in adaptation or ATSSS rules as previously described.

### Communication of Traffic Steering Adaptation

Once the UE and the network have agreed on using adaptive traffic steering capabilities and/or adaptive steering modes, it is vital that whenever the UE or network dynamically adapts data traffic, the other party is informed so the traffic adaptation can operate efficiently. The UE or the network may communicate the traffic adaptation using either control plane signaling or user plane signaling as described below.

This section describes messages that are exchanged between the UE and the network via the RAN Node. The messages exchanged between the UE and RAN node can be: RRC Messages, messages based on PMF or SDAP protocol sent via the user plane, or NAS-SM messages. When RRC message or user plane message is used, the message is sent from the UE to the RAN node and the RAN node delivers the contents of the message to the UPF. When NAS-SM message is used, the message is sent from the UE to the SMF and the SMF delivers the contents of the message to the RAN Node. The messages may contain the following information: request for adaptive traffic steering, a QFI for applying adaptive traffic steering, adaptive steering percentages, new adaptive steering mode, performance measurements for adaptation, and frequency of performance measurements and adaptation.

In addition, messages are exchanged between the RAN Node and UPF via the GTP-U protocol. For example, the UL PDU SESSION INFORMATION message defined in 3GPP TS 38.415 may be enhanced to carry the messages. The messages may contain the following information: request for adaptive traffic steering, a QFI for applying adaptive traffic steering, adaptive steering percentages, new adaptive steering mode, performance measurements for adaptation, and frequency of performance measurements and adaptation.

### Control Plane Signaling using NAS Protocol

After the MA PDU session is established and an initial steering mode is selected, the UE and/or the network may need to modify the traffic steering configuration based on changes in UE or network conditions. From the UE perspective, the communication of data traffic adaptation may be included in a service request, UL NAS Transport, or in a PDU session modification request. As an example, a UE may have moved from one location to another location where the non-3GPP access network is now the preferred access network, whereas previously, the 3GPP access network was defined as the higher priority access. Thus, the UE would like to notify the network that the non-3GPP access is the higher priority access and the 3GPP access is now the lower priority access while preserving the MA PDU session. The Priority-based steering mode in Release 16 was fixed to whatever access network was defined as the higher priority access and the other access as the lower priority access when the MA PDU session was established. Without the ability to adapt traffic steering, the UE would be forced to use the 3GPP access network as the higher priority access until congestion on the 3GPP access network forces the UE to split and/or switch traffic to the non-3GPP access network. In this case, the coverage of the non-3GPP access network may even be better than the coverage of the 3GPP access network and if the UE is actively streaming data, user experience may be degraded. In another example, the UE has been configured to use the Load-balancing steering mode where 50% of the traffic is split between the 3GPP access and the other 50% of the traffic to the non-3GPP access. If one of the access networks, whether 3GPP or non-3GPP access network, becomes overloaded, the UE is not able to adapt the splitting percentages since it is fixed. With the support of adaptive traffic steering, the UE is able to request the modification of the MA PDU session to adapt the splitting and/or steering percentages or altogether change the steering mode to one more suitable to the current conditions. Table 5 of the Appendix proposes an enhancement to the 5GSM capability information element where a new value option for ATSSS-ST can be used by the UE to communicate to the network the desire to adapt traffic steering to a different configuration than the currently configured steering mode and/or steering percentages. This information element may be included in a PDU session modification request the UE sends to the network whenever the UE would like to communicate for traffic steering adaptation functionality.

A network may also communicate to the UE to enable data traffic adaptation as a result of changes in the network load or other conditions in which the network would like to adapt traffic steering. The network may perform a PDU session modification command to modify a PDU session. In the modification command, the network may include the enhancement as proposed for the 5GSM cause information clement shown in Table 6 of the Appendix. In this example, the network may specific whether UL or DL traffic steering is being requested. When the Request to adapt traffic steering is sent, the network may also include adaptation rules in the ATSSS container. If the adaptation rules are incorporated within the ATSSS rules, then the ATSSS rules with traffic adaptation information are included in the ATSSS container. The SMF may be triggered to send the PDU session modification command based on network data analytics or by an OAM command, which may be in response to a report that the 3GPP access network may be overloaded and suggest that data traffic be moved from the 3GPP access network to the non-3GPP access network if possible. The SMF may also trigger the PDU session modification command in response to receiving usage reports from the UPF concerning UPF loading and/or performance measurements obtained by the UPF. Furthermore, the SMF may trigger PDU session modification command due to commands by an OAM entity, when network maintenance is being performed, or during network function migration and orchestration.

### User Plane Signaling Using PMF Protocol

Communication of dynamic traffic adaptation between the UE and the network may also be made using user plane signaling while data communications are active. One approach may be to send the traffic adaptation message using the PMF protocol encapsulated with data traffic or as a standalone message separate from the data traffic. For the case where a higher layer steering functionality such as MPTCP is utilized, the PMF protocol may still be used for communicating traffic adaptation between the UE and the network. Table 7 of the Appendix shows the message types proposed for the PMF protocol traffic adaptation request and response messages and the measurement request and response messages, respectively. Both the UE and the network may send the traffic adaptation request to communicate a request for traffic steering adaptation. A traffic adaptation response is then returned to indicate whether the traffic adaptation request was granted. Similarly, performance measurements may be exchanged between the UE and the network to assist with making traffic adaptation decisions. While traffic adaptation request and response messages will be described here, measurement request and response messages will be described hereinafter. The message enumerations are based on the current definitions in 3GPP TS 24.193, but they may be enumerated differently if other PMF protocol messages are defined.

Table 8 and Table 9 of the Appendix show, respectively, the proposed Traffic Adaptation request and response message contents. In the request message, the UE or network may communicate to the other entity what new steering mode and in which direction the traffic adaptation is being requested, e.g., for UL only traffic, for DL only traffic, or for both UL and DL traffic. A response message is returned to the requester showing whether traffic adaptation is granted and for which direction traffic adaptation is granted. Table 10, Table 11, and Table 12 of the Appendix show the individual information elements for the New Steering Mode, the Adaptation Direction, and the Granted Adaptation, respectively. Note that both UL and DL traffic adaptation are defined separately and a UE or the network may request to adapt data traffic on both the UL and DL directions independently and be granted the ability to adapt data traffic in both directions. For cases in which the UE or network would like to request different steering modes between the UL and DL directions, the UE or network may send separate requests. Alternatively, Table 10 may be enumerated such that the upper 4-bits are associated with DL steering mode and the lower 4-bits are associated with UL steering mode. In the alternative case, the UE or network is able to select different UL and DL steering modes within a single request.

The enumerations proposed in Table 10 is just one example of how the new adaptive traffic steering functionalities may be encoded. If the new adaptive traffic steering functionalities are defined as modes of operations, then the enumeration may be defined differently, e.g., as shown in Table 13 of the Appendix. In this example enumeration, bits 7 and 8 are enumerations of adaptive based and reflective adaptation modes of operation, respectively. These modes of operation may be enabled in addition to the selected steering modes as defined by bits 1 to 3 and the modes of operation may even be applied to new steering modes that may be defined in the future.

Using the alternative enumeration enables the minimization of signaling the Traffic Adaptation request for certain cases. For example, a UE may request a new steering mode for UL adaptation and have the same steering mode be applied to DL adaptation by enabling the reflective adaptation mode of operation. Using the alternate enumeration from Table 13, the UE is able to send a single request to make such a request. Note that other enumerations may be defined to support the adaptive traffic steering functionalities as well. Another alternate would be to define the adaptive based functionality as a steering mode and the reflective adaptation as a mode of operation.

An alternative to the Traffic Adaptation request and response examples previously shown is the incorporation of steering percentages within these messages. In this scenario, the UE may have already been informed that the CN is allowing the UE to make dynamic traffic steering decisions based on UE conditions such as obtained from performance measurements or internal UE states. For example, performance measurements obtained by the UE may indicate that a better throughput is found on a certain access and the UE would like to steer the majority of traffic towards that access. Another example may be the UE would like to conserve battery level and only transmit and receive over one access. As a result, the UE would like to steer all traffic over that one access.

For these scenarios, the UE may dynamically adapt traffic steering towards the desired access(es). However, the UE needs to communicate such adaptation to the UPF, so the network is aware of what the UE is doing. As such, the UE may send the UPF a request as shown in the example of Table 14 of the Appendix. The request, which may be a PMFP Traffic Adaptation request, includes the QFI the traffic adaptation applies to, the UL steering percentages for both 3GPP and non-3GPP accesses, whether reflective DL steering percentages are requested, and the frequency with which performance measurements and adaptation control are made.

Table 15 of the Appendix shows the QFI, which is a scalar quantity that identifies the QoS flow that the traffic adaptation is being applied to. There may be multiple QoS flows associated with the UE and each may have their own steering mode and/or adaptive steering control. Note that the QFI may be instead another identifier used to track the adaptive steering between the UL and the DL. The adaptation percentages shown in Table 14 of the Appendix represent the UL steering percentage for both 3GPP and non-3GPP accesses that the UE intends to use. Included within the adaptation percentages and as shown in the example of Table 16 of the Appendix is an option for the UE to request the mirroring of DL steering percentages from the UL steering percentages. The UE may request from the UPF such reflective steering percentages for cases in which the UE would like to have both UL and DL steering percentages be the same. The reason may be that performance measurements indicate one access provides better throughput than the other access or that the UE would like to conserve battery and only transmit over one access. Table 16 of the Appendix also shows that traffic adaptation may be triggered when measurements of both 3GPP and non-3GPP accesses exceed a threshold value provided by the network. This may be considered as an error condition for when measurement thresholds are applied as subsequently described. Finally, the PMFP traffic adaptation request may also include adaptation frequency information as shown in Table 17 of the Appendix in which the frequency of performance measurements and adaptive steering are specified or proposed by the UE for use. The measurement period specifies the frequency in which performance measurements should be obtained while the adaptation period represents the frequency in which the UE may adapt traffic steering. Note the examples shown in Table 16 and Table 17 of the Appendix are example configurations for the associated parameters and they may be specified with different enumeration or values than what is shown.

The traffic adaptation response may be similar to the one presented in Table 9 but with additional information, such as indication that DL traffic steering will reflect UL steering percentages and new measurement and adaptation frequencies different than what the UE sent.

### User Plane Signaling Without Using PMF Protocol

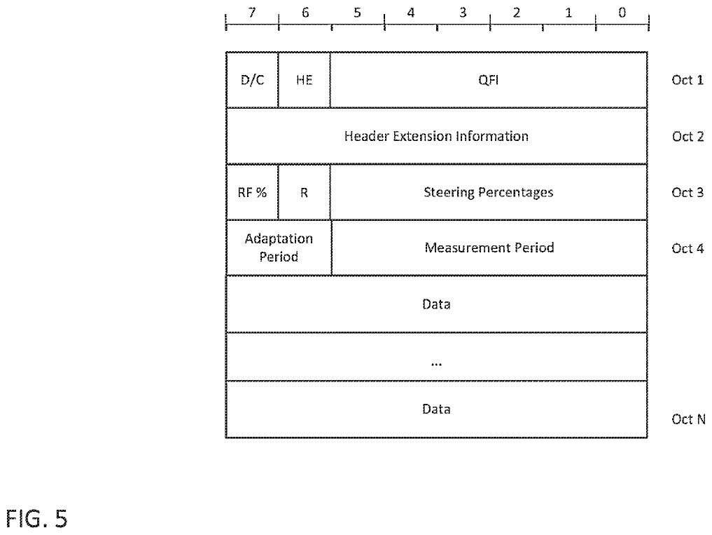

In the absence of the PMF Protocol, the UE may utilize the Service Data Adaptation Protocol (SDAP) defined in 3GPP TS 37.324 to send the traffic adaptation information through the RAN node to the UPF. The SDAP layer already carries QoS flow information in the SDAP header. As such, the SDAP header may be enhanced as shown in FIG. 5 where the steering percentages and the adaptation frequency information previously proposed are added to the UL data PDU. A header extension (HE) bit is shown in octet 1 to represent that the SDAP header has been extended to include the extra traffic steering adaptation information as shown. An optional header extension information octet may be added to indicate what information follows in the SDAP header and to also provide the ability for future SDAP header enhancements. In the absence of the header extension information octet, the steering percentages and the adaptation frequency information may be included as the first two octets following the QFI field. The RF % bit (bit 7 of octet 3) shown in FIG. 5 represents the UE requesting reflective DL traffic steering percentages derived from the UL traffic steering percentages found in bits [5:0] of octet 3. Both the measurement period and the adaptation period may then be carried in octet 4.

An alternative to the enhancement shown in FIG. 5 may be to transmit only the steering percentages as part of the data payload. In this alternative, the HE bit shown in FIG. 5 may instead be used to indicate that traffic adaptation percentages are included as the first octet at the beginning of the data payload. Both the measurement period and the adaptation period may have already been signaled to the UE/UPF by the SMF and are therefore pre-determined by the network and cannot be dynamically controlled by the UE/UPF.

Thus far, the SDAP header enhancements were made in the SDAP data PDU; however, the traffic adaptation information may also be carried in an SDAP control PDU as described in 3GPP TS 37.324. In this case, only control information is carried in the SDAP PDU and thus, the traffic adaptation information may be included in octets 2 and 3 as part of the SDAP header of the SDAP control PDU.

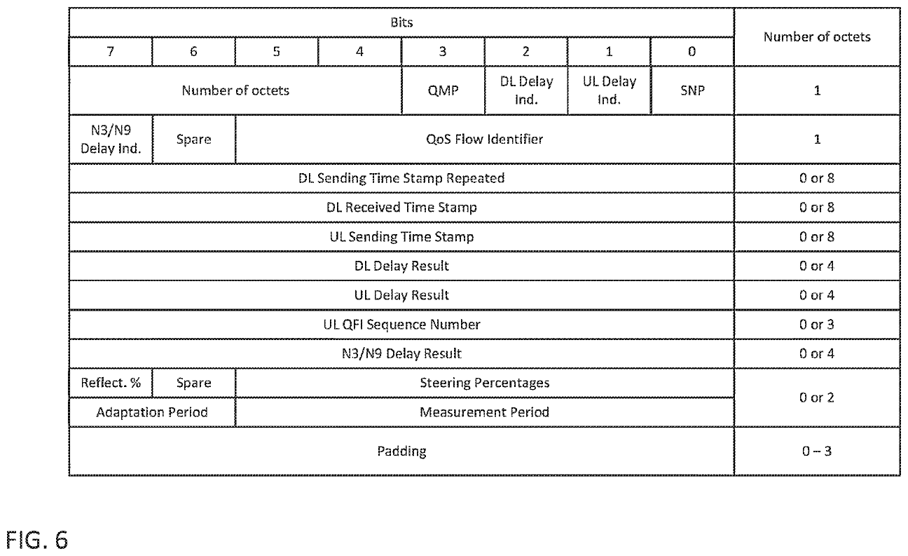

After the RAN node receives the traffic adaptation information from the UE, the RAN node may then send the information to the UPF in an UL PDU Session Information message. The RAN node sends the message to the UPF using the GTP-U protocol over the NG-U/N3 interface. An example of the enhancements to the UL PDU Session Information message to support adaptive traffic steering is shown in FIG. 6. The enhancements are shown with the same parameters as proposed in FIG. 5 for the SDAP header. Since the QFI is already included as part of the UL PDU Session Information message, only the steering percentages and the adaptation frequency information are needed to be added. FIG. 6 shows the information being added to the end of the message prior to any padding bits but this information may be placed elsewhere in the message, e.g., in the octets after the QFI octet.

### Performance Measurement Configuration and Exchange

Previously, it was described that messages are exchanged between the UE and UPF to signal traffic adaptation. This section describes how the UE and UPF are configured to send the performance measurement messages (e.g., what messages to send and when to send them) that are used to assist with the traffic adaptation.

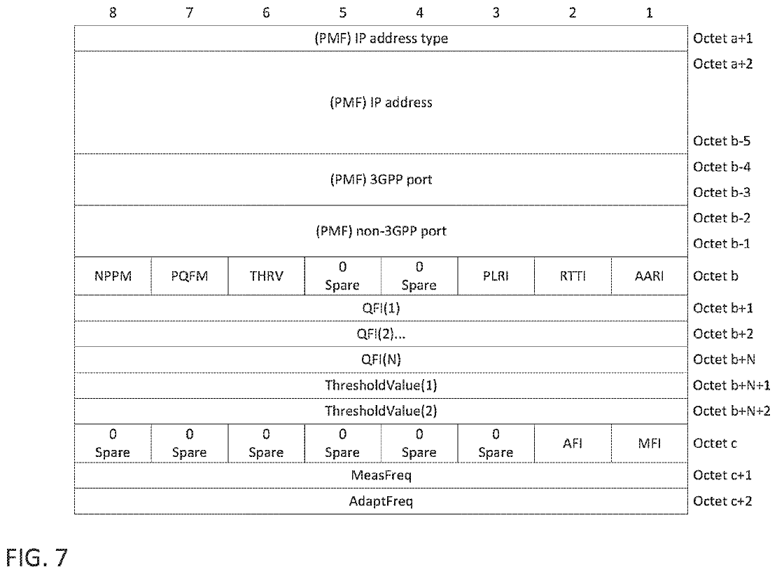

After a UE has established or modified an MA PDU session, the network may return Measurement Assistance Information (MAI) to the UE that identify what performance measurements should be obtained, that may include whether per QoS flow measurement is enabled, the frequency with which to obtain the measurements, and other information the UE can use when adapting traffic. In addition to what is defined in FIG. 6.1.5.2-1 of 3GPP TS 24.193, it is proposed additional assistance information be added to support adaptive traffic steering functionality. Note the proposed enhancements shown in FIG. 7 is only an example of one embodiment.

The new mappings for octet b show the addition of both RTT and PLR measurement indicators in the MAI to provide for more flexibility with allowing the use of different measurements for different steering modes. In Rel-16 ATSSS steering modes, there was mostly a one-to-one correspondence between performance measurement and steering mode. For example, RTT is associated with Smallest-Delay steering mode and the Access Availability report was associated with Active-Standby, Load-Balancing, and Priority-based steering modes. The new steering modes introduced in Rel-17 are dynamic and hence could be associated with whichever measurements provide the best indicator of performance. Thus, when the adaptive traffic steering is enabled, the network may select an appropriate performance measurement indicative of the desired performance metric. As a result, explicit indicators for each available measurement are added to the MAI.

In line with obtaining more accurate measurements for adaptive traffic steering purposes, the Rel-17 ATSSS study determined that per QoS flow measurements better reflect the quality of an access when compared with the default QoS flow for measurement. To that end, the PQFM indicator of octet b shown in FIG. 7 provides a mechanism for the network to signal to the UE that per QoS flow measurement is enabled for the corresponding list of QFIs available in the MAI. The list of QFIs may be presented to the UE to indicate per QoS flow measurement may be obtained for those QFIs and the UE may take into consideration the list of QFIs when determining which measurements may be obtained on a per QoS flow basis. The UE may determine, based e.g., on the QFI list and on QoS and ATSSS rules, which application traffic may benefit from per QoS flow measurements.

Associated with the added flexibility of Rel-17 ATSSS enhancements, the introduction of threshold values for RTT and PLR measurements are also supported in octet b. The THRV indicator and the corresponding ThresholdValue information elements are added to enable the network to provide threshold values for RTT and PLR measurements. These threshold values are provided by the network to indicate when the UE may adapt traffic if the performance measurement exceeds the provided value. For example, an RTT threshold value of 1 ms may be provided by the network and when the UE obtains a RTT measurement exceeding 1 ms for an access, the UE may adapt traffic (e.g., adjust the traffic split percentages between the accesses or switch traffic to another access) until the RTT measurement for that access decreases below 1 ms. Similarly, a PLR threshold value of 1% may signal that the UE may adapt traffic (e.g., adjust the traffic split percentages between the accesses or switch traffic to another access) until the packet loss rate drops below 1%.

Table 18 of the Appendix also shows additional enumerations for the Threshold Value information element. Bit 8 indicates the measurement selector bit (either RTT or PLR) that the threshold value applies to. Note that the same threshold value applies to both 3GPP and non-3GPP accesses. Bits 7:6 describes the action the UE/UPF should take whenever the measurements of both 3GPP and non-3GPP access exceed the threshold value. This case is referred to as an error condition in this disclosure and will be described in more details hereinafter.

The PQFM indicator is utilized whenever the network determines that per Qos flow measurements would be more accurate and beneficial to use when steering traffic. When the PQFM indicator is set to 1, the network may also provide a list of QFIs to indicate to the UE which QoS flows may benefit from providing per QoS flow measurements. When the PQFM indicator is set to 0, then performance measurements are obtained using the default QoS flow. After having received the list of QFIs in the MAI, the UE may wait until there is traffic for the QFI before obtaining performance measurements for those QFIs. That is, the UE is not required to perform per QoS flow measurement unless the UE has traffic on the QFI. This would reduce the amount of unnecessary performance measurement traffic the UE would need to support.

Finally, the NPPM indicator specifies whether performance measurements are obtained using the PMF protocol or through some non-PMF protocols. When the NPPM indicator is set to 1, the UE utilizes a different protocol other than the PMF protocol to obtain performance measurements. When the NPPM indicator is set to 0, the UE utilizes the PMF protocol to obtain the performance measurements that are enabled by the MAI. Currently, the PMF protocol is the only protocol defined for transmitting performance measurements, however, some options will be presented hereinafter on how performance measurements may be obtained without the use of the PMF protocol. Note the IP address and port numbers in the MAI will still be used for obtaining performance measurements regardless of whether PMF protocol is selected. Table 18 of the Appendix shows an example embodiment of the new additions to octet b from what is defined in 3GPP TS 24.193.

Up until this point, the same set of IP address and port numbers were used for obtaining the performance measurements for all QoS flows. However, it may be that multiple sets of IP address and/or port numbers are needed to simplify the exchange of performance measurements. Multiple sets of IP addresses and/or port numbers may be specified to differentiate between default QoS measurements and per QoS flow measurements. Furthermore, each of the per QoS flow measurements may be configured to have a unique set of IP address and port numbers. Note that it may be simpler that the IP address remains the same while individual port numbers are assigned for each QoS flow.

FIG. 7 and Table 18 of the Appendix also shows a new octet c and the corresponding definitions, respectively, to support adaptive traffic steering. The MFI indicator is used to specify the frequency with which performance measurements should be obtained. When the MFI indicator is set to 1, the network also provides the measurement frequency MeasFreq, which specifies the period between performance measurements. This value may be specified as an absolute time value (e.g., in ms) or some other enumeration relative to a base time unit. The network may also include an AFI indicator to specify the frequency with which traffic adaptation can be made. When the AFI indicator is set to 1, the network also provides the adaptation frequency AdaptFreq, which specifies the limit in which the UE may make traffic adaptation decisions. The network may want to limit the times the UE is able to adapt traffic to avoid undue burden to the RAN node in adjusting radio resources to accommodate the adaptation and to minimize traffic associated with adaptation signaling between the UE and the UPF.

Previously, it was proposed that in the absence of the PMF protocol, that enhancements to the SDAP header may be used to convey traffic steering adaptations between the UE and the UPF. Similarly, the same proposal may be applied to the performance measurements as well. The measurement messages may be carried within the SDAP header as new enhancements or alternatively, the measurement information may be carried within the data payload and passed up to the application layer at the UE or the UPF. In the former case, there may require some cross-layer protocol communications between the SDAP protocol and the application protocol while in the latter case, an indication may be required to inform the SDAP layer that measurement information is available for the application layer.

Another method for configuring the performance measurements may be through the use of URSP rules (or similar rules). In this method, the measurement assistance information enhancements (e.g., as described in Table 18 of the Appendix) may be included in enhanced URSP rule information.

After the UE or UPF has been configured with the measurement requirements, each can begin to obtain measurements using the newly proposed PMFP Measurement request and response messages shown in Table 19 and Table 20, respectively, of the Appendix. The PMFP Measurement request has two usage: one, to indicate the start or end of a measurement period using the Measurement Info element, and two, to provide the requested measurement value after the measurement period ends. In the former usage, a PMFP Measurement request is sent with only the Measurement Info element and in the latter usage, the PMFP Measurement request is sent with both the Measurement Info and Measurement Value elements.

An example of the Measurement Info clement is shown in Table 21 where the QFI, the measurement type, and a begin/end indicator are provided. A UE or the UPF may trigger the start of the indicated measurement by sending the PMFP Measurement request with bit 7 (e.g., the measurement begin indicator) set to 1. A PMFP Measurement response without a value is returned to acknowledge the request. At the end of the measurement period, a PMFP Measurement request is sent again but with bit 7 (e.g., the measurement end indicator) set to 0. Once again, a PMFP Measurement response is returned, but this time, a value for the measurement may be returned, e.g., for the PLR measurement, a value that indicates the number of packets received for the measurement period. Hence, this value is used to compute the performance measurement. Note that for the RTT measurement, the RTT is calculated for each request/response message pair and does not need a value for the measurement to be returned in a PMFP Measurement response.

After the measurement period ends, the UE or UPF may send the computed measurement in another PMFP Measurement request. This time, both the Measurement Info and the Measurement Value are sent in the request message. The message may include: QFI that the measurement is associated with, the measurement type (e.g., RTT or PLR), the value of the performance measurement, and from which access (e.g., 3GPP or non-3GPP) the measurement was obtained from. The RTT measurement may represent an average value for the duration of the measurement period.

Similar to the case of communicating adaptative traffic steering, the measurement info that are sent by the UE or the UPF may be sent using the PMF protocol or some other protocol, such as SDAP. The same information, e.g., QFI, measurement value, access identifier (e.g., 3GPP or non-3GPP), etc., may also be included as data payload of messages sent between the UE and the UPF or in RRC signaling where measurements are provided by the UE to the RAN node.

### Measurement Exceeding Threshold for 3GPP and Non-3GPP Accesses

Previously, it was described that threshold values provided by the network could be used to determine the quality of an access. If the measurement (e.g., RTT or PLR) of one access exceeds a threshold, it may indicate degradation of that access and traffic steering may be adapted to the other access. The assumption was that the measurement for the other access would not exceed the threshold and therefore, was the better access to steer traffic to. However, if the measurement for both 3GPP and non-3GPP accesses exceed the threshold value, then it may be considered an error case as there is no definitive traffic steering decision that could be made. What the UE and the UPF do in this scenario is not defined. There may be two potential solutions to address this scenario. First, the network may pre-emptively provide the UE and UPF guidance on what to do in such a situation in the ATSSS and N4 rules. Second, the network may allow the UE and the UPF to make the determination of what to do, e.g., that one access is better than the other access based on the difference between each measurement and that of the threshold value. For example, if the PLR measurement for 3GPP access is 3% and the PLR measurement for non-3GPP access is 2% and the threshold value is 1%, then the UE may determine to split a higher percentage of traffic on the non-3GPP access or to switch all traffic on the non-3GPP access. The non-3GPP access has a lower PLR than the 3GPP access and hence is the “better” access for adaptation. In response to such a condition, the UE or UPF may inform the other as the reason for traffic adaptation and the UPF may notify the PCF via the SMF of traffic adaptation due to the error case. The PCF, in turn, may send the UE and UPF updated ATSSS and N4 rules, respectively, if none were previously provided. The rules may provide guidance on how to handle such a condition in the future. Alternatively, the PCF may note the event occurred and not send updated rules to the UE/UPF. The PCF may provide a notification to either the OAM or the NWDAF that such event occurred for analytics and tracking purposes.

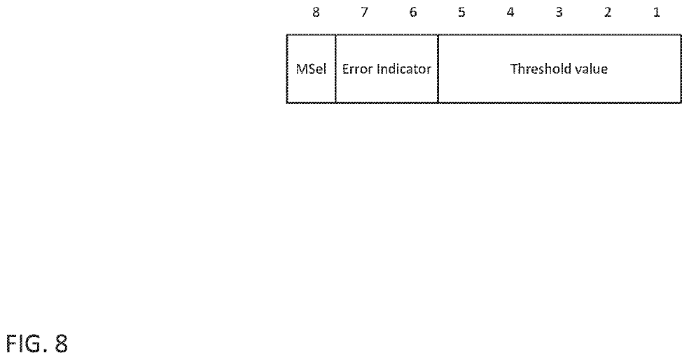

In the former solution, measurement assistance information may be provided to the UE and the UPF an indication of which access to steer traffic to in the event of an error condition. FIG. 8 shows an example of the presence of an error indication for the Threshold Value information element shown in FIG. 7. Table 18 of the Appendix shows the detailed enumerations for the Threshold Value information element. As shown, the network may configure the MAI to inform the UE and the UPF which access to select, 3GPP or non-3GPP, when the error condition occurs. On the other hand, the network may allow the UE and UPF to make the determination individually based on implementation, e.g., based on the result of the measurement difference with the threshold value for each access as previously described.

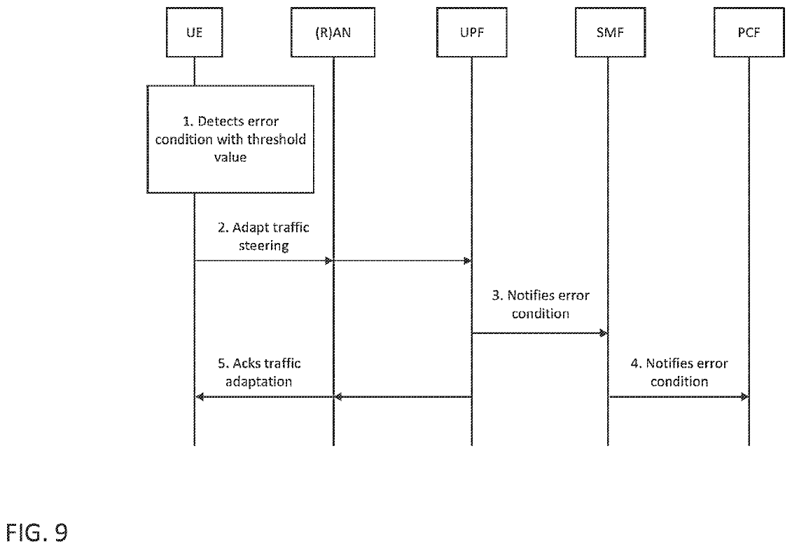

After the UE receives the ThresholdValue information element in the MAI and after applying the threshold value to the corresponding measurement, if the UE detects that an error condition has occurred, e.g., when both measurements from 3GPP and non-3GPP accesses exceed the threshold value, the UE may then perform traffic adaptation as configured by the error indicator. The UE may inform the UPF of the traffic adaptation as previously proposed but also provide indication that the traffic adaptation was a result of the error condition. In the message sent to the UPF, the UE may also include an error indication that triggered the traffic adaptation, an identifier for the measurement and threshold value that generated the error, the measurement values from both 3GPP and non-3GPP accesses, and a timestamp of when the error occurred, etc. FIG. 9 shows an example procedure in which the UE performs traffic adaptation as a result of the detection of an error condition with applying measurement threshold for 3GPP and non-3GPP access measurements.

Step 1: The UE detects an error condition in which both measurements from 3GPP and non-3GPP access exceed the threshold value for that measurement. Based on information in the MAI, the UE may perform adaptation by steering traffic to the access configured by the network. Alternatively, and if allowed by the network to individually make traffic adaptation decisions, the UE splits the traffic where the higher percentage is targeting the access whose measurement difference from the threshold value is lower than the measurement difference from the threshold value of the other access.

Step 2: The UE then sends a traffic adaptation message through the RAN node to the UPF. The traffic adaptation message may include the QFI of the traffic under consideration, the UL steering percentages for 3GPP and non-3GPP accesses, a request to have DL traffic adaptation to reflect the UL traffic adaptation, the reason for this traffic adaptation (e.g., based on error condition in applying threshold value), and measurement and adaptation periods the UE will use for adapting future traffic. The UE may also include other information about the error condition, such as a time stamp of when the error condition was detected, an identifier for the measurement, the measurement values from both 3GPP and non-3GPP accesses, the threshold value used in the detection of the error condition, and the traffic adaptation that was performed.

Step 3: The UPF may report to the SMF via the N4 interface of the occurrence of the error condition. The notification may be an N4 Session Level Reporting procedure where the UPF sends the SMF information about the error occurrence, such as an indication of error encounter when applying measurement against the corresponding threshold, the measurement identifier, a time stamp of when the error occurs, the measurement values from both 3GPP and non-3GPP accesses, the threshold value, and the traffic adaptation performed as a result of the error. The SMF may have previously subscribed to be notified of such occurrences or provide an indicator in N4 rules sent to the UPF to report such occurrence.

Step 4: The SMF may further notify the PCF of the occurrence of the error condition by performing e.g., an SM Policy Association modification procedure. Using the Npcf_SMPolicyControl_Update service operation, the SMF includes information about the error condition, such as a time stamp of the error condition, a measurement identifier, the measurement values from both 3GPP and non-3GPP accesses, the threshold value, and the resulting action took by the UE. The SMF may also report the event to NWDAF if there was a subscription by NWDAF to be notified of such a condition. Upon receiving the notification, the PCF may trigger an update of measurement assistance information with information of how to handle error cases in the future.

Step 5: The UPF may respond to the UE an acknowledgement of the traffic adaptation request. In the response, the UPF may provide new measurement and adaptation periods that the UE should use while adapting future traffic. These values may be the same as the ones provided by the UE in step 2 or the values may be new values that the UPF provides to the UE to override the previously sent values. In the former case, it may not be necessary for the UPF to resend the original values sent by the UE but in the latter case, the new values should be sent so the UE can apply them to future traffic adaptation. The UPF may have obtained the new values from the SMF due to network configuration changes or from policy changes in the PCF.

### Graphical User Interface

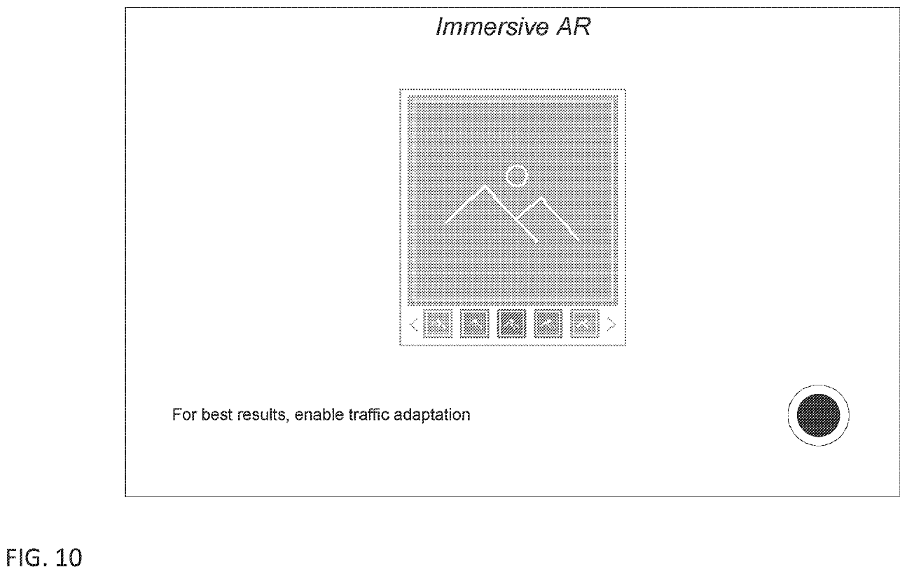

FIG. 10 shows an example GUI presented to a user upon the launch of an AR application in which there is an option to enable adaptive traffic steering on a UE. The option provides the AR application the ability to dynamically adapt traffic steering on the UE so the application can provide an immersive user experience. The option may be preconfigured as part of the application installation procedure, configured as an option within the application, realized as a permission granted to the application, or provided as a prompt for the user to select.

### Variations

A UE may request from a network the ability to dynamically adapt traffic steering. In the request, the UE includes one of an indication of support for adaptive traffic steering capability or a request for an adaptive steering mode or modes. The adaptive traffic steering capability may include an operational mode in addition to a selected steering mode. The request may require the network to configure a steering mode to allow the UE to dynamically adapt traffic steering.

In the request, the UE may also provide other information to assist the network with choosing appropriate steering mode(s). The other information may include one or more of application type, application ID, bandwidth requirement, mobility information, measurement information such as signal strengths and traffic latency, network identifiers such as SSID, a list of steering modes, etc.

The request may take the form of a MA PDU session establishment or MA PDU session modification request, for example.

An adaptive traffic steering capability of the UE may be included in an initial, mobility update, or periodic update registration request.

In response, the network may return to the UE a status of the request and may include one or more of rules indicating a select steering mode, an adaptive steering mode, or a list of steering modes and the conditions on adapting traffic steering. The steering modes may be specified as an adaptive mode, a reflective adaptation mode, or a list of steering modes in which adaptation may be made from

Traffic steering adaptation rules may be used to communicate conditions in which traffic adaptation may be made by the UE and/or the network. The adaptation rules may be included in a communication to request for enabling adaptive traffic steering, for example, or in a response to grant adaptive traffic steering functionality. The adaptation rules may include one or more of: a steering mode used for traffic adaptation, the direction (UL, DL, or both UL and DL) of traffic adaptation, the adaptive traffic steering percentages allowed, the period in which traffic adaptation is enabled, and the trigger conditions in which traffic adaptation may be enabled. Triggers may be communicated, arise from analytics, or be caused by due to performance measurements exceeding certain thresholds.

The adaptation rules may be incorporated as part of existing ATSSS and N4 rules generated for an MA PDU session. The network (e.g., an SMF) may generate the adaptation rules as part of process to grant MA PDU session. The UE or network may generate and provide adaptation rules to request for adaptive traffic steering capability.

The UE and the network can communicate to each other when traffic adaptation is to be performed to signal whether traffic adaptation may be performed for UL only, DL only, or both UL and DL.

The UE and network may use control plane signaling using NAS protocol to exchange information regarding traffic steering. For example, indications may be made using an enhanced 5G session management capability information clement and/or management cause information element.

The UE and network may further use user plane signaling using PMF protocol to exchange information regarding traffic steering. Indications may be made in a PMFP traffic adaptation request message, for example, that includes an indication of a new steering mode, the direction for the requested adaptation, possibly an adaptation rule with which to perform the traffic adaptation, an identifier the traffic adaptation is applied to, the adaptive steering percentages, request for reflective DL steering percentages, indicator that adaptation was made due to error condition with threshold value, and the measurement and adaptation frequency, etc.

Indications may be returned in a response, PMFP traffic adaptation response message, wherein the indication grants the ability to adapt traffic according to adaptation rules provided (previously or as part of response message), in which direction traffic adaptation is allowed, an indication that DL traffic steering will reflect UL steering percentages, and new measurement and adaptation frequencies different than what the UE sent.

Similarly, traffic steering information may be exchanged using enhanced user plane signaling without using PMF protocol. For example, indications may be made in a new request as part of SDAP enhancements, wherein the request message include an indication of a new steering mode, the direction for the requested adaptation, possibly an adaptation rule with which to perform the traffic adaptation, an identifier the traffic adaptation is applied to, the adaptive steering percentages, request for reflective DL steering percentages, indicator that adaptation was made due to error condition with threshold value, and the measurement and adaptation frequency

The adaptation request may be triggered by direct communication, based on analytics result or predictions, or based on performance measurement. Alternatively, a request may be made due to changes in UE or network conditions, wherein the conditions include one or more of battery level of the UE, mobility of the UE, application running on the UE, user configuration, analytics generated, performance measurement exceeding a threshold, loading, etc.

Performance measurement configuration and exchange may include the network providing measurement assistance information to the UE that includes measurement type indicators (e.g., RTT, PLR), per QoS measurement indication, a list of QFIs for per QoS measurement, a threshold value, a non-PMF protocol measurement indicator, a measurement frequency, and/or an adaptation frequency. The network may send a PMFP Measurement request, e.g., including a QFI, measurement begin/end indicators, a measurement type, a measurement value, and/or an indication of whether measurement obtained from 3GPP or non-3GPP access.

Error handling may address performance measurements from 3GPP and non-3GPP accesses both exceeding configured threshold values, whereby the network provides indications in measurement assistance information to UE and UPF specifying what to do. For example, the UE and UPF may be allowed by network to determine how to proceed, based on comparison of difference between measurement and threshold value for each access (3GPP and non-3GPP)—whichever access has smaller difference is the access the UE/UPF should use.

Detected error conditions may be communicated in a number of ways. The UE may notify the UPF, for example, and the UPF notify the SMF. The SMF in turn may notify the PCF and NWDAF. The PCF may trigger update of measurement assistance information to provide information to UE of how to handle the error case in the future. The UPF may respond with new measurement and adaptation duration.

### EXAMPLE ENVIRONMENTS

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHZ, and the provision of new ultra-mobile broadband radio access above 7 GHZ. The flexible radio access is expected to consist of a new, non-backwards compatible radio access in new spectrum below 7 GHZ, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (cMBB) ultra-reliable low-latency Communication (URLLC), massive machine type communications (mMTC), network operation (e.g., network slicing, routing, migration and interworking, energy savings), and enhanced vehicle-to-everything (e2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

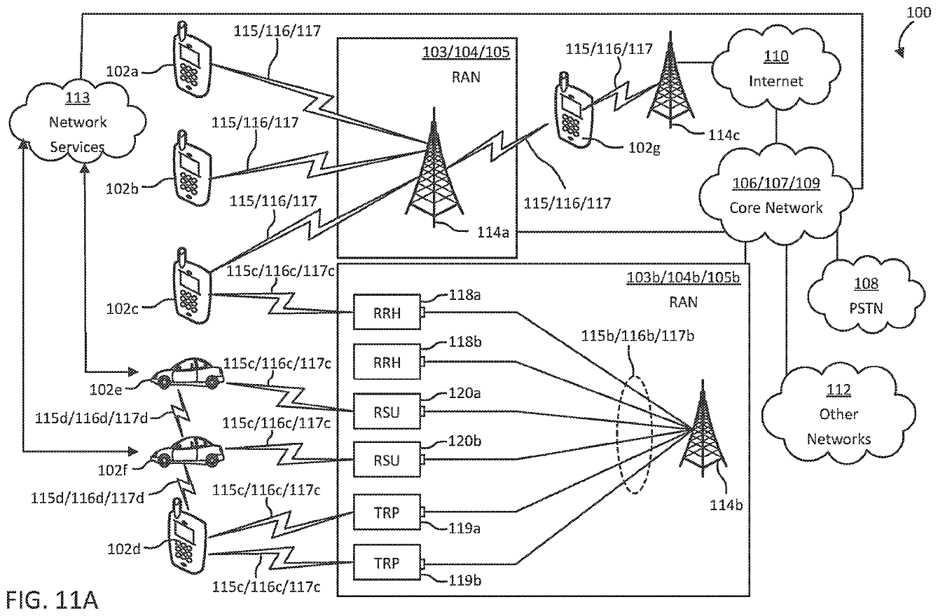

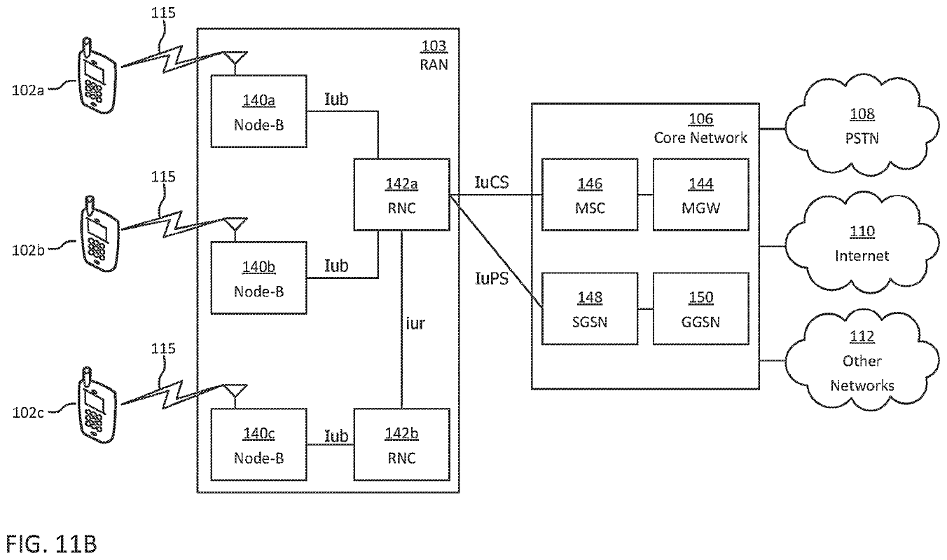

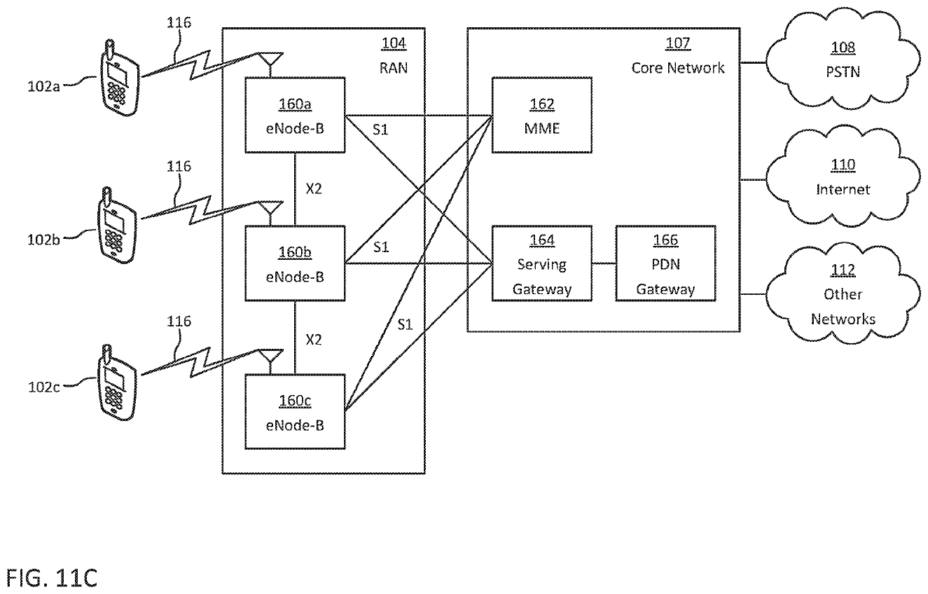

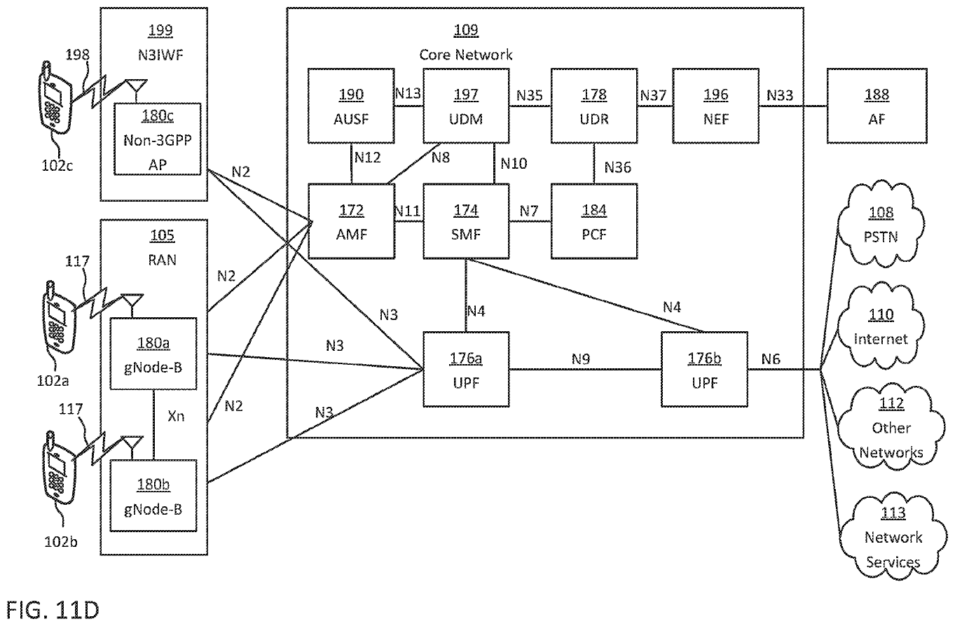

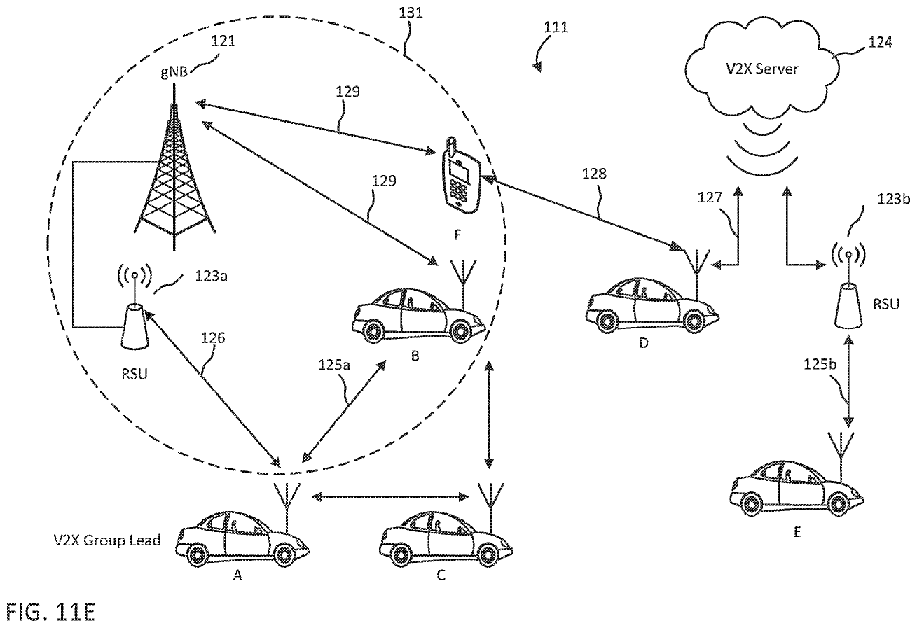

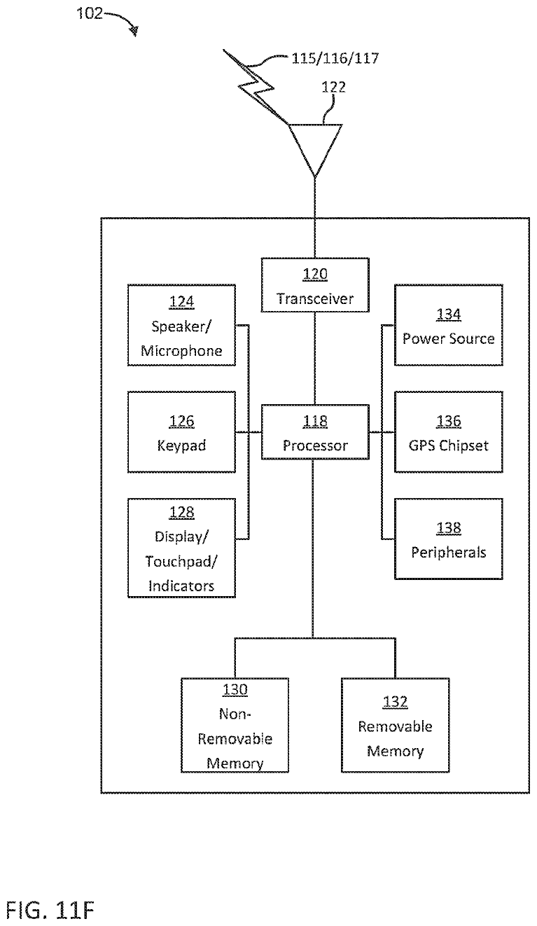

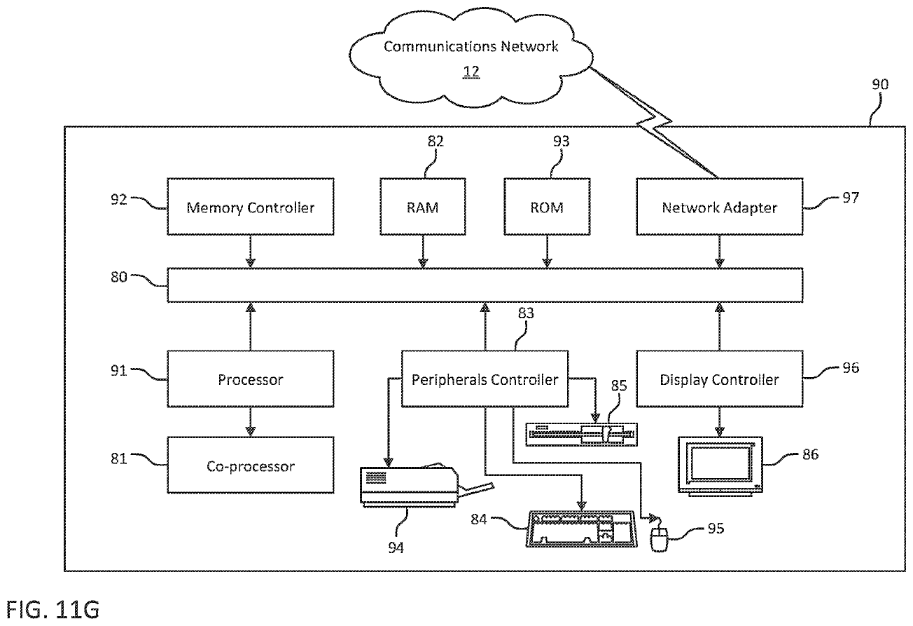

FIG. 11A illustrates an example communications system 100 in which the systems, methods, and apparatuses described and claimed herein may be used. The communications system 100 may include wireless transmit/receive units (WTRUs) 102a, 102b, 102c, 102d, 102c, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSc server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 11A, each of the WTRUs 102 is depicted in FIGS. 11A-11E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 11A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102c, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 11A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102c, may utilize a cellular-based RAT (e.g., WCDMA, CDMA2000, GSM, LTE, LTE-A, NR, etc.) to establish a picocell or femtocell. As shown in FIG. 11A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 11A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102c, and 102f in the communications system 100 may include multi-mode capabilities, e.g., the WTRUs 102a, 102b, 102c, 102d, 102c, and 102f may include multiple transceivers for communicating with different wireless networks over different wireless links. For example, the WTRU 102g shown in FIG. 11A may be configured to communicate with the base station 114a, which may employ a cellular-based radio technology, and with the base station 114c, which may employ an IEEE 802 radio technology.

Although not shown in FIG. 11A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 11B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 11B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 11B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 11B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an luPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 11C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of cNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 11C, the eNode-Bs 160a, 160b, and 160c may communicate with one another over an X2 interface.

The core network 107 shown in FIG. 11C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the cNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 11D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 11D, the gNode-Bs 180a and 180b may communicate with one another over an Xn interface, for example.

The core network 109 shown in FIG. 11D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. x1G.

In the example of FIG. 11D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 11D shows that network functions directly connect to one another, however, it should be appreciated that they may communicate via routing agents such as a diameter routing agent or message buses.

In the example of FIG. 11D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 11D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5interface. The N15 and N5 interfaces are not shown in FIG. 11D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance, and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 11D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, which serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 11A, 11C, 11D, and 11E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 11A-11E are provided by way of example only, and it is understood that the subject matter disclosed and claimed herein may be embodied or implemented in any similar communication system, whether presently defined or defined in the future.

FIG. 11E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Roadside Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUS A, B, C, D, E, and F may communicate with each other over a Uu interface 129 via the gNB 121 if they are within the access network coverage 131. In the example of FIG. 11E, WTRUs B and F are shown within access network coverage 131. WTRUS A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 11E, WRTU D, which is outside of the access network coverage 131, communicates with WTRU F, which is inside the coverage 131.

WTRUS A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 11F is a block diagram of an example apparatus or device WTRU 102 that may be configured for wireless communications and operations in accordance with the systems, methods, and apparatuses described herein, such as a WTRU 102 of FIG. 11A, 11B, 11C, 11D, or 11E. As shown in FIG. 11F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 11F and described herein.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 11F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 11A) over the air interface 115/116/117 or another UE over the air interface 115d/116d/117d. For example, the transmit/receive clement 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 11F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 11G is a block diagram of an exemplary computing system 90 in which one or more apparatuses of the communications networks illustrated in FIGS. 11A, 11C, 11D and 11E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 11A-11E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable, and non-removable media implemented in any non-transitory (e.g., tangible, or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

### APPENDIX

TABLE 1
Enhancements to URSP Rules for Adaptive Traffic Steering

| | | | PCF permitted to | |
|---|---|---|---|---|
| Information name | Description | Category | modify in URSP | Scope |
| Route Selection | Determines the order in which the Route | Mandatory | Yes | UE context |
| Descriptor Precedence | Selection Descriptors are to be applied. | (NOTE 1) | | |
| Route selection | This part defines the route selection | Mandatory | | |
| components | components | (NOTE 2) | | |
| SSC Mode Selection | One single value of SSC mode. | Optional | Yes | UE context |
| | (NOTE 5) | | | |
| Network Slice | Either a single value or a list of values of S- | Optional | Yes | UE context |
| Selection | NSSAI(s). | (NOTE 3) | | |
| DNN Selection | Either a single value or a list of values of | Optional | Yes | UE context |
| | DNN(s). | | | |
| PDU Session Type | One single value of PDU Session Type | Optional | Yes | UE context |
| Selection | | (NOTE 8) | | |
| Non-Seamless Offload | Indicates if the traffic of the matching | Optional | Yes | UE context |
| indication | application is to be offloaded to non-3GPP | (NOTE 4) | | |
| | access outside of a PDU Session. | | | |
| Access Type | Indicates the preferred Access Type (3GPP or | Optional | Yes | UE context |
| preference | non-3GPP or Multi-Access or “Multi-Access | | | |
| | with Adaptive Traffic Steering”) when the UE | | | |
| | establishes a PDU Session for the matching | | | |
| | application. | | | |
| Adaptive Traffic | Indicates the UE may request to enable adaptive | Optional | Yes | UE context |
| Steering Capability | traffic steering capability or to request adaptive | | | |
| | traffic steering mode(s) from the network | | | |
| Route Selection | This part defines the Route Validation Criteria | Optional | | |
| Validation Criteria | components | | | |
| (NOTE 6) | | | | |
| Time Window | The time window when the matching traffic is | Optional | Yes | UE context |
| | allowed. The RSD is not considered to be valid | | | |
| | if the current time is not in the time window. | | | |
| Location Criteria | The UE location where the matching traffic is | Optional | Yes | UE context |
| | allowed. The RSD rule is not considered to be | | | |
| | valid if the UE location does not match the | | | |
| | location criteria. | | | |

NOTE 1:
Every Route Selection Descriptor in the list shall have a different precedence value.
NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all“ URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.
NOTE 6:
The Route Selection Descriptor is not considered valid unless all the provided Validation Criteria are met.
NOTE 7:
In this Release of specification, inclusion of the Validation Criteria in Roaming scenarios is not considered.
NOTE 8:
When the PDU Session Type is “Ethernet” or “Unstructured”, this component shall be present.

TABLE 2
Attributes of Traffic Steering Adaptation Rules

| Attribute Name | Description |
|---|---|
| Steering mode | The steering mode that this adaptation rule applies |
| | to |
| Allowed direction | The direction (UL, DL, or both) of traffic adaptation |
| for adaptation | that is allowed; for DL adaptation, the UE provides |
| | the UPF adaptation rule |
| Adaptation period | The duration in which traffic steering adaptation is |
| | allowed |
| Triggers for | The conditions in which traffic adaptation are |
| adaptation | triggered: via communication, performance |
| | measurements, analytics, etc. |
| Traffic adaptation | The ranges (in percentages) that is allowed for |
| range | traffic adaptation in UL and DL directions; this |
| | attribute may be specified as maximum and |
| | minimum adaptation percentages |

TABLE 3
Example of new parameters for ATSSS rule

| Length of access selection descriptor (octet s-3) | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 1 | 1 | If the steering mode is smallest delay |
| 0 | 0 | 0 | 0 | 0 | 1 | 0 | 0 | If the steering mode is not smallest delay, |
| | | | | | | | | adaptive based, or reflective adaptation |
| 0 | 0 | 0 | 0 | 0 | 1 | 1 | 1 | If the steering mode is adaptive based or |
| | | | | | | | | reflective adaptation |

All other values are spare.
Steering mode (octet s-1)

The steering mode descriptor field shall be encoded by one octet (octet s-1) as follows:

| | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | Active-standby |
| 0 | 0 | 0 | 0 | 0 | 0 | 1 | 0 | Smallest delay |
| 0 | 0 | 0 | 0 | 0 | 0 | 1 | 1 | Load balancing |
| 0 | 0 | 0 | 0 | 0 | 1 | 0 | 0 | Priority based |
| 0 | 0 | 0 | 0 | 0 | 1 | 0 | 1 | Adaptive based |
| 0 | 0 | 0 | 0 | 0 | 1 | 1 | 0 | Reflective adaptation |

All other values are spare.
Steering mode information (octet s)

If the steering mode is defined as adaptative based, octet s shall be encoded to show the
conditions in which trafficadaptation may be triggered:

| | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | Adaptation triggered by communication |
| 0 | 0 | 0 | 0 | 0 | 0 | 1 | 0 | Adaptation triggered by measurements |
| 0 | 0 | 0 | 0 | 0 | 1 | 0 | 0 | Adaptation triggered by analytics |

Steering mode information (octet s)

If the steering mode is defined as reflective adaptation, octet s shall be encoded to show
the direction the adaptation is reflected from:

| | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | Reflect the DL adaptation to that on UL traffic |
| 0 | 0 | 0 | 0 | 0 | 0 | 1 | 0 | Reflect the UL adaptation to that on DL traffic |

Steering adaptation percentages (octet s + 1, s + 2)

If adaptative based steering is enabled, the maximum and minimum traffic adaptation percentages
are defined as follows(note octet s + 2 applies to UL traffic adaptation percentages and octet s + 3
applies to DL traffic adaptation percentages):

| | | | | | | | | |
|---|---|---|---|---|---|---|---|---|
| 8 | 7 | 6 | 5 | 4 | 3 | 2 | 1 | |
| X | X | X | X | 0 | 0 | 0 | 1 | Min traffic adaptation: 100% |
| X | X | X | X | 0 | 0 | 1 | 0 | Min traffic adaptation: 90% |
| X | X | X | X | 0 | 0 | 1 | 1 | Min traffic adaptation: 80% |
| X | X | X | X | 0 | 1 | 0 | 0 | Min traffic adaptation: 70% |
| X | X | X | X | 0 | 1 | 0 | 1 | Min traffic adaptation: 60% |
| X | X | X | X | 0 | 1 | 1 | 0 | Min traffic adaptation: 50% |
| X | X | X | X | 0 | 1 | 1 | 1 | Min traffic adaptation: 40% |
| X | X | X | X | 1 | 0 | 0 | 0 | Min traffic adaptation: 30% |
| X | X | X | X | 1 | 0 | 0 | 1 | Min traffic adaptation: 20% |
| X | X | X | X | 1 | 0 | 1 | 0 | Min traffic adaptation: 10% |
| X | X | X | X | 1 | 0 | 1 | 1 | Min traffic adaptation: 0% |
| 0 | 0 | 0 | 1 | X | X | X | X | Max traffic adaptation: 100% |
| 0 | 0 | 1 | 0 | X | X | X | X | Max traffic adaptation: 90% |
| 0 | 0 | 1 | 1 | X | X | X | X | Max traffic adaptation: 80% |
| 0 | 1 | 0 | 0 | X | X | X | X | Max traffic adaptation: 70% |
| 0 | 1 | 0 | 1 | X | X | X | X | Max traffic adaptation: 60% |
| 0 | 1 | 1 | 0 | X | X | X | X | Max traffic adaptation: 50% |
| 0 | 1 | 1 | 1 | X | X | X | X | Max traffic adaptation: 40% |
| 1 | 0 | 0 | 0 | X | X | X | X | Max traffic adaptation: 30% |
| 1 | 0 | 0 | 1 | X | X | X | X | Max traffic adaptation: 20% |
| 1 | 0 | 1 | 0 | X | X | X | X | Max traffic adaptation: 10% |
| 1 | 0 | 1 | 1 | X | X | X | X | Max traffic adaptation: 0% |

All other values are spare
Adaptation period (octet s + 3)

If adaptative based steering is enabled, the period that traffic steering adaptation is enabled:

| | | | | | | | | |
|---|---|---|---|---|---|---|---|---|
| 8 | 7 | 6 | 5 | 4 | 3 | 2 | 1 | |
| 0 [symbol] | 0 | 0 | X | X | X | X | X | Adaptation enabled for next number of hours |
| 0 | 0 | 1 | 0 | 0 | 0 | 0 | 1 | Adaptation valid until PDU session is released |
| 0 | 0 | 1 | 0 | 0 | 0 | 1 | 0 | Adaptation valid until event (e.g., mobility) |
| 0 | 0 | 1 | 0 | 0 | 1 | 0 | 0 | Adaptation valid until cancel by communication |

All other values are spare
Adaptation period (octet s + 3) - alternative

If adaptative based steering is enabled, octet s + 3 specifies the measurement and adaptation periods:

| 8 | 7 | 6 | 5 | 4 | 3 | 2 | 1 | |
|---|---|---|---|---|---|---|---|---|
| X | X | 0 | Meas_Period | | | | | Measurement period in 5 ms increments |
| 0 | 0 | 0 | X | X | X | X | X | On-demand adaptation |
| 0 | 1 | 0 | X | X | X | X | X | Adaptation period is twice the measurement period |
| 1 | 0 | 0 | X | X | X | X | X | Adaptation period is four times the measurement period |
| 1 | 1 | 0 | X | X | X | X | X | Adaptation period is eight times the measurement period |

All other values are spare

TABLE 4
Multi-Access Rule Enhancements

| [symbol] Attribute | | Description | Comment |
|---|---|---|---|
| N4 Session ID | | Identifies the N4 session associated to | |
| | | this MAR. | |
| Rule ID | | Unique identifier to identify this rule. | |
| Steering functionality | | Indicates the applicable traffic steering | |
| | | functionality: | |
| | | Values “MPTCP functionality”, | |
| | | “ATSSS-LL functionality”. | |
| Steering mode | | Values “Active-Standby”, “Smallest | |
| | | Delay”, “Load Balancing”, “Priority- | |
| | | based” or “Adaptive-based”. | |
| Adaptive Capability | | Adaptation enabled | Enables the UPF to |
| | | | dynamically adapt |
| | | | traffic |
| Per-Access | Forwarding | The Forwarding Action Rule ID | |
| Forwarding | Action Rule | identifies a forwarding action that has | |
| | ID | to be applied. | |
| Action | Weight | Identifies the weight for the FAR if | The weights for all |
| information | | steering mode is “Load Balancing” | FARs need to sum up to |
| | | | 100 |
| (NOTE 1) | Priority | Values “Active or Standby” or “High or | “Active or Standby” for |
| [symbol] | | Low” for the FAR | “Active-Standby” |
| | | | steering mode and |
| | | | “High or Low” for |
| | | | “Priority-based” steering |
| | | | mode |
| | Max/Min | The maximum and minimum steering | The upper and lower |
| | Steering | percentages allowed for traffic | limits that are available |
| | Percentages | adaptation | for traffic adaptation. |
| [symbol] | Measurement | Indicates the period for when | Sets the frequency with |
| | Period | measurements need to be obtained | which measurements |
| | | | may be obtained |
| | Adaptation | Indicates the period for when adaptation | Sets the frequency with |
| | Period | may be made | which traffic adaptation |
| | | | may be made |
| | List of Usage | Every Usage Reporting Rule ID | This enables the SMF to |
| | Reporting | identifies a measurement action that has | request separate usage |
| | Rule ID(s) | to be applied. | reports for different |
| | | | FARs (e.g., different |
| | | | accesses) |

NOTE 1:
The Per-Access Forwarding Action information is provided per access type (e.g., 3GPP access or Non-3GPP access).

TABLE 5
Adaptive Traffic Steering Enhancement to 5GSM capability
information element

5GSM capability value
RqoS(octet 3, bit 1)
This bit indicates the 5GSM capability to support reflective QoS.

| | |
|---|---|
| 0 | Reflective QoS not supported |
| 1 | Reflective QoS supported |

Multi-homed IPv6 PDU session (MH6-PDU) (octet 3, bit 2)
This bit indicates the 5GSM capability for Multi-homed IPv6
PDU session.

| | |
|---|---|
| 0 | Multi-homed IPv6 PDU session not supported |
| 1 | Multi-homed IPv6 PDU session supported |

Ethernet PDN type in S1 mode (EPT-S1) (octet 3, bit 3)
This bit indicates UE's 5GSM capability for Ethernet PDN type in S1
mode.

| | |
|---|---|
| 0 | Ethernet PDN type in S1 mode not supported |
| 1 | Ethernet PDN type in S1 mode supported |

Supported ATSSS steering functionalities and steering modes
(ATSSS-ST) (octet 3, bits 4 to 7)
These bits indicate the 5GSM capability of ATSSS steering
functionalities and steering modes

| | |
|---|---|
| 0 0 0 0 | ATSSS not supported |
| 0 0 0 1 | ATSSS Low-Layer functionality with any steering mode |
| | supported |
| 0 0 1 0 | MPTCP functionality with any steering mode and ATSSS-LL |
| | functionality with only active-standby steering mode supported |
| 0 0 1 1 | MPTCP functionality with any steering mode and ATSSS-LL |
| | functionality with any steering mode supported |
| 0 1 X X | ATSSS support for adaptive traffic steering |

All other values are reserved.
Transfer of port management information containers (TPMIC)
(octet 3, bit 8)
This bit indicates the 5GSM capability to support transfer of port
management information containers

| | |
|---|---|
| 0 | Transfer of port management information containers not |
| | supported |
| 1 | Transfer of port management information containers supported |

All other bits in octet 3 to 15 are spare and shall be coded as zero, if the
respective octet is included in the information element.

TABLE 6
Adaptive Traffic Steering Enhancement to 5GSM cause information element

[symbol]

| Cause value (octet 2) | | | | | | | | |
|---|---|---|---|---|---|---|---|---|
| Bits | | | | | | | | |
| 8 | 7 | 6 | 5 | 4 | 3 | 2 | 1 | |
| 0 | 0 | 0 | 0 | 1 | 0 | 0 | 0 | Operator determined barring |
| 0 | 0 | 0 | 1 | 1 | 0 | 1 | 0 | Insufficient resources |
| 0 | 0 | 0 | 1 | 1 | 0 | 1 | 1 | Missing or unknown DNN |
| 0 | 0 | 0 | 1 | 1 | 1 | 0 | 0 | Unknown PDU session type |
| 0 | 0 | 0 | 1 | 1 | 1 | 0 | 1 | User authentication or authorization failed |
| 0 | 0 | 0 | 1 | 1 | 1 | 1 | 1 | Request rejected, unspecified |
| 0 | 0 | 1 | 0 | 0 | 0 | 0 | 0 | Service option not supported |
| 0 | 0 | 1 | 0 | 0 | 0 | 0 | 1 | Requested service option not subscribed |
| 0 | 0 | 1 | 0 | 0 | 0 | 1 | 0 | Service option temporarily out of order |
| 0 | 0 | 1 | 0 | 0 | 0 | 1 | 1 | PTI already in use |
| 0 | 0 | 1 | 0 | 0 | 1 | 0 | 0 | Regular deactivation |
| 0 | 0 | 1 | 0 | 0 | 1 | 1 | 0 | Network failure |
| 0 | 0 | 1 | 0 | 0 | 1 | 1 | 1 | Reactivation requested |
| 0 | 0 | 1 | 0 | 1 | 0 | 0 | 1 | Semantic error in the TFT operation |
| 0 | 0 | 1 | 0 | 1 | 0 | 1 | 0 | Syntactical error in the TFT operation |
| 0 | 0 | 1 | 0 | 1 | 0 | 1 | 1 | Invalid PDU session identity |
| 0 | 0 | 1 | 0 | 1 | 1 | 0 | 0 | Semantic errors in packet filter(s) |
| 0 | 0 | 1 | 0 | 1 | 1 | 0 | 1 | Syntactical error in packet filter(s) |
| 0 | 0 | 1 | 0 | 1 | 1 | 1 | 0 | Out of LADN service area |
| [symbol] 0 | 0 | 1 | 0 | 1 | 1 | 1 | 1 | PTI mismatch |
| 0 | 0 | 1 | 1 | 0 | 0 | 1 | 0 | PDU session type IPv4 only allowed |
| 0 | 0 | 1 | 1 | 0 | 0 | 1 | 1 | PDU session type IPv6 only allowed |
| 0 | 0 | 1 | 1 | 0 | 1 | 1 | 0 | PDU session does not exist |
| 0 | 0 | 1 | 1 | 1 | 0 | 0 | 1 | PDU session type IPv4v6 only allowed |
| 0 | 0 | 1 | 1 | 1 | 0 | 1 | 0 | PDU session type Unstructured only allowed |
| 0 | 0 | 1 | 1 | 1 | 1 | 0 | 1 | 1 PDU session type Ethernet only allowed |
| 0 | 1 | 0 | 0 | 0 | 0 | 1 | 1 | Insufficient resources for specific slice and DNN |
| 0 | 1 | 0 | 0 | 0 | 1 | 0 | 0 | Not supported SSC mode |
| 0 | 1 | 0 | 0 | 0 | 1 | 0 | 1 | Insufficient resources for specific slice |
| 0 | 1 | 0 | 0 | 0 | 1 | 1 | 0 | Missing or unknown DNN in a slice |
| 0 | 1 | 0 | 1 | 0 | 0 | 0 | 1 | Invalid PTI value |
| 0 | 1 | 0 | 1 | 0 | 0 | 1 | 0 | Maximum data rate per UE for user-plane integrity protection is too low |
| 0 | 1 | 0 | 1 | 0 | 0 | 1 | 1 | Semantic error in the QoS operation |
| 0 | 1 | 0 | 1 | 0 | 1 | 0 | 0 | Syntactical error in the QoS operation |
| 0 | 1 | 0 | 1 | 0 | 1 | 0 | 1 | Invalid mapped EPS bearer identity |
| 0 | 1 | 0 | 1 | 1 | 1 | 1 | 1 | Semantically incorrect message |
| 0 | 1 | 1 | 0 | 0 | 0 | 0 | 0 | Invalid mandatory information |
| 0 | 1 | 1 | 0 | 0 | 0 | 0 | 1 | Message type non-existent or not implemented |
| 0 | 1 | 1 | 0 | 0 | 0 | 1 | 0 | Message type not compatible with the protocol state |
| 0 | 1 | 1 | 0 | 0 | 0 | 1 | 1 | Information element non-existent or not implemented |
| 0 | 1 | 1 | 0 | 0 | 1 | 0 | 0 | Conditional IE error |
| 0 | 1 | 1 | 0 | 0 | 1 | 0 | 1 | Message not compatible with the protocol state |
| 0 | 1 | 1 | 0 | 1 | 1 | 1 | 1 | Protocol error, unspecified |
| 1 | 0 | 0 | 0 | 0 | 0 | 0 | 1 | Request to adapt UL traffic steering |
| 1 | 0 | 0 | 0 | 0 | 0 | 1 | 0 | Request to adapt DL traffic steering |

Any other value received by the UE shall be treated as 0010 0010, ″service option temporarily
out of order″. Any other value received by the network shall be treated as 0110 1111,
″protocol error, unspecified″.

TABLE 7
PMF Protocol Message type

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | PMFP ECHO REQUEST message |
| 0 | 0 | 0 | 0 | 0 | 0 | 1 | 0 | PMFP ECHO RESPONSE message |
| 0 | 0 | 0 | 0 | 0 | 0 | 1 | 1 | PMFP ACCESS REPORT message |
| 0 | 0 | 0 | 0 | 0 | 1 | 0 | 0 | PMFP ACKNOWLEDGEMENT message |
| 0 | 0 | 0 | 0 | 0 | 1 | 0 | 1 | PMFP TRAFFIC ADAPTATION REQUEST message |
| 0 | 0 | 0 | 0 | 0 | 1 | 1 | 0 | PMFP TRAFFIC ADAPTATION RESPONSE message |
| 0 | 0 | 0 | 0 | 0 | 1 | 1 | 1 | PMFP MEASUREMENT REQUEST message |
| 0 | 0 | 0 | 0 | 1 | 0 | 0 | 0 | PMFP MEASUREMENT RESPONSE message |

All other values are reserved

TABLE 8
PMFP TRAFFIC ADAPTATION REQUEST message content

| [symbol] | | | | | |
|---|---|---|---|---|---|
| IEI | Information Element | Type/Reference | Presence | Format | Length |
| | PMFP traffic adaptation | Message type | M | V | 1 |
| | request message identity | Table 7 | | | |
| | EPTI | Extended procedure transaction | M | V | TBD |
| | | identity | | | |
| | | 6.2.2.2 of 3GPP TS 24.193 | | | |
| | New steering mode | New steering mode for adaptation | M | V | 1 |
| | | Table 10 | | | |
| | Adaptation direction | Adaptation direction | M | V | 1 |
| | | Table 11 | | | |
| TBD | Padding | Padding | O | TVL-E | 3-1000 |
| | | 6.2.2.6 of 3GPP TS 24.193 | | | |

TABLE 9
PMFP TRAFFIC ADAPTATION RESPONSE message content

| [symbol] | | | | | |
|---|---|---|---|---|---|
| IEI | Information Element | Type/Reference | Presence | Format | Length |
| | PMFP traffic adaptation | Message type | M | V | 1 |
| | response message identity | Table 7 | | | |
| | EPTI | Extended procedure | M | V | TBD |
| | | transaction identity | | | |
| | | 6.2.2.2 of 3GPP TS 24.193 | | | |
| | Adaptation granted | Adaptation that is granted | M | V | 1 |
| | | Table 12 | | | |
| TBD | Padding | Padding | O | TVL-E | 3-1000 |
| | | 6.2.2.6 of 3GPP TS 24.193 | | | |

TABLE 10
New Steering Mode information element

| Bits | | | | | | | | |
|---|---|---|---|---|---|---|---|---|
| 8 | 7 | [symbol] | 5 | 4 | 3 | 2 | 1 | |
| 0 | 0 | 0 | 0 | 0 | 0 | 0 | 1 | Active-standby |
| 0 | 0 | 0 | 0 | 0 | 0 | 1 | 0 | Smallest delay |
| 0 | 0 | 0 | 0 | 0 | 0 | 1 | 1 | Load balancing |
| 0 | 0 | 0 | 0 | 0 | 1 | 0 | 0 | Priority based |
| 0 | 0 | 0 | 0 | 0 | 1 | 0 | 1 | Adaptive based |
| 0 | 0 | 0 | 0 | 0 | 1 | 1 | 0 | Reflective adaptation |

All other values are reserved

TABLE 11
Adaptation Direction information element

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | Request UL adaptation |
| 0 | 0 | 0 | 0 | 0 | 0 | 1 | 0 | Request DL adaptation |

All other values are reserved

TABLE 12
Granted Adaptation information element

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | UL adaptation granted |
| 0 | 0 | 0 | 0 | 0 | 0 | 1 | 0 | DL adaptation granted |

All other values are reserved

TABLE 13
Alternative Steering Mode information element enumeration

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | Active-standby |
| 0 | 0 | 0 | 0 | 0 | 0 | 1 | 0 | Smallest delay |
| 0 | 0 | 0 | 0 | 0 | 0 | 1 | 1 | Load balancing |
| 0 | 0 | 0 | 0 | 0 | 1 | 0 | 0 | Priority based |
| 0 | 1 | 0 | 0 | 0 | X | X | X | Adaptive based mode of operation |
| 1 | 0 | 0 | 0 | 0 | X | X | X | Reflective adaptation mode of |
| | | | | | | | | operation |

All other values are reserved

TABLE 14
Alternative PMFP TRAFFIC ADAPTATION REQUEST message content

| | Information Element | | | | |
|---|---|---|---|---|---|
| IEI | [symbol] | Type/Reference | Presence | Format | Length |
| | PMFP traffic adaptation | Message type | M | V | 1 |
| | request message identity | Table 7 | | | |
| | EPTI | Extended procedure transaction identity | M | V | TBD |
| | | 6.2.2.2 of 3GPP TS 24.193 | | | |
| | QoS Flow ID | QoS Flow Identifier | M | V | 1 |
| | | Table 15 | | | |
| | Adaptation percentages | Adaptive steering percentages | M | V | 1 |
| | | Table 16 | | | |
| | Adaptation frequency | Adaptation frequency | M | V | 1 |
| | | Table 17 | | | |
| TBD | Padding | Padding | O | TVL-E | 3-1000 |
| | | 6.2.2.6 of 3GPP TS 24.193 | | | |

TABLE 15
QoS Flow Identifier information element

| Bits | | | | | | | |
|---|---|---|---|---|---|---|---|
| 8 | 7 | 6 | 5 | 4 | 3 | 2 | 1 |

| | | | |
|---|---|---|---|
| X | X | QFI | QoS Flow ID |

All other values are reserved

TABLE 16
Adaptive Steering Percentages information element

| Bits | | | | | | | | |
|---|---|---|---|---|---|---|---|---|
| 8 | 7 | 6 | 5 | 4 | 3 | 2 | 1 | |
| X | 0 | 0 | 0 | 0 | 0 | 0 | 0 | UL steering: 0% over 3GPP, 100% over non-3GPP |
| X | 0 | 0 | 0 | 0 | 0 | 0 | 1 | UL steering: 5% over 3GPP, 95% over non-3GPP |
| X | 0 | 0 | 0 | 0 | 0 | 1 | 0 | UL steering: 10% over 3GPP, 90% over non-3GPP |
| X | 0 | 0 | 0 | 0 | 0 | 1 | 1 | UL steering: 15% over 3GPP, 85% over non-3GPP |
| X | 0 | 0 | 0 | 0 | 1 | 0 | 0 | UL steering: 20% over 3GPP, 80% over non-3GPP |
| X | 0 | 0 | 0 | 0 | 1 | 0 | 1 | UL steering: 25% over 3GPP, 75% over non-3GPP |
| X | 0 | 0 | 0 | 0 | 1 | 1 | 0 | UL steering: 30% over 3GPP, 70% over non-3GPP |
| X | 0 | 0 | 0 | 0 | 1 | 1 | 1 | UL steering: 35% over 3GPP, 65% over non-3GPP |
| X | 0 | 0 | 0 | 1 | 0 | 0 | 0 | UL steering: 40% over 3GPP, 60% over non-3GPP |
| X | 0 | 0 | 0 | 1 | 0 | 0 | 1 | UL steering: 45% over 3GPP, 55% over non-3GPP |
| X | 0 | 0 | 0 | 1 | 0 | 1 | 0 | UL steering: 50% over 3GPP, 50% over non-3GPP |
| X | 0 | 0 | 0 | 1 | 0 | 1 | 1 | UL steering: 55% over 3GPP, 45% over non-3GPP |
| X | 0 | 0 | 0 | 1 | 1 | 0 | 0 | UL steering: 60% over 3GPP, 40% over non-3GPP |
| X | 0 | 0 | 0 | 1 | 1 | 0 | 1 | UL steering: 65% over 3GPP, 35% over non-3GPP |
| X | 0 | 0 | 0 | 1 | 1 | 1 | 0 | UL steering: 70% over 3GPP, 30% over non-3GPP |
| X | 0 | 0 | 0 | 1 | 1 | 1 | 1 | UL steering: 75% over 3GPP, 25% over non-3GPP |
| X | 0 | 0 | 1 | 0 | 0 | 0 | 0 | UL steering: 80% over 3GPP, 20% over non-3GPP |
| X | 0 | 0 | 1 | 0 | 0 | 0 | 1 | UL steering: 85% over 3GPP, 15% over non-3GPP |
| X | 0 | 0 | 1 | 0 | 0 | 1 | 0 | UL steering: 90% over 3GPP, 10% over non-3GPP |
| X | 0 | 0 | 1 | 0 | 0 | 1 | 1 | UL steering: 95% over 3GPP, 5% over non-3GPP |
| X | 0 | 0 | 1 | 0 | 1 | 0 | 0 | UL steering: 100% over 3GPP, 0% over non-3GPP |
| X | 1 | X | X | X | X | X | X | Adaptation due to error condition of measurement exceeding |
| | | | | | | | | threshold for 3GPP and non-3GPP accesses |
| 1 | X | X | X | X | X | X | X | Reflective DL steering percentages from UL steering percentages |

All other values are reserved

TABLE 17
Adaptation Frequency information element

| Bits | | | | | | | | |
|---|---|---|---|---|---|---|---|---|
| 8 | 7 | 6 | 5 | 4 | 3 | 2 | 1 | |
| X | X | Meas_Period | | | | | | Measurement period in 5 ms increments |
| 0 | 0 | X | X | X | X | X | X | On-demand adaptation |
| 0 | 1 | X | X | X | X | X | X | Adaptation period is twice the measurement period |
| 1 | 0 | X | X | X | X | X | X | Adaptation period is four times the measurement period |
| 1 | 1 | X | X | X | X | X | X | Adaptation period is eight times the measurement period |

All other values are reserved

TABLE 18
Measurement Assistance Information Enhancements

PMF IP address type (octet a + 1) is set as follows:
Bits

| | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | IPv4 |
| 0 | 0 | 0 | 0 | 0 | 0 | 1 | 0 | IPv6 |
| 0 | 0 | 0 | 0 | 0 | 0 | 1 | 1 | IPv4IPv6 |

All other values are spare.
If the PMF IP address type indicates IPv4, then the PMF IP address field contains an IPv4 address in 4 octets.
If the PMF IP address type indicates IPv6, then the PMF IP address field contains an IPv6 address in 16 octets.
If the PMF IP address type indicates IPV4IPv6, then the PMF IP address field contains two IP addresses. The first PMF IP
address is an IPv4 address in 4 octets and the second PMF IP address is an IPV6 address in 16 octets.
PMF 3GPP port (octets b-4 - b-3) is allocated port number associated with the 3GPP access network.
PMF non-3GPP port (octets b-2 - b-1) is allocated port number associated with the non-3GPP access network.
AARI (access availability reporting indicator) (octet b, bit 1) is set as follows:

| | |
|---|---|
| 0 | Do not report the access availability |
| 1 | Report the access availability |

RTTI (round trip time indicator) (octet b, bit 2) is set as follows:

| | |
|---|---|
| 0 | RTT measurement is not applicable for per QoS flow measurement |
| 1 | RTT measurement is applicable for per QoS flow measurement |

PLRI (packet loss ratio indicator) (octet b, bit 3) is set as follows:

| | |
|---|---|
| 0 | PLR measurement is not applicable for per QoS flow measurement |
| 1 | PLR measurement is applicable for per QoS flow measurement |

THRV (threshold values) (octet b, bit 6) is set as follows:

| | |
|---|---|
| 0 | No threshold value available for performance measurements |
| 1 | Threshold value(s) available for performance measurements |

PQFM (per QoS flow measurement) (octet b, bit 7) is set as follows:

| | |
|---|---|
| 0 | Per QoS flow measurement is disable |
| 1 | Pex QoS flow measurement is enable |

NPPM (non PMF protocol measurement) (octet b, bit 8) is set as follows:

| | |
|---|---|
| 0 | Use PMF protocol for measurement |
| 1 | Use non-PMF protocol for measurement |

QFI(): a list of QFI for which performance measurements are obtained
Bits (6:1) contains QFI value associated with performance measurement obtained for per QoS flow measurement
requirement. Bit PQFM needs to be 1.
ThresholdValue(): one or more threshold values used for performance measurement. Bit THRV needs to be 1.

| | | | | | | | | |
|---|---|---|---|---|---|---|---|---|
| 8 | 7 | 6 | 5 | 4 | 3 | 2 | 1 | |
| X | X | X | 0 | 0 | 0 | 0 | 0 | \ |
| to | | | | | | | | } Threshold value |
| X | X | X | 1 | 1 | 1 | 1 | 1 | / |
| X | 0 | 1 | X | X | X | X | X | Error condition: allow UE/UPF to select adaptation |
| X | 1 | 0 | X | X | X | X | X | Error condition: select adaptation to 3GPP access |
| X | 1 | 1 | X | X | X | X | X | Error condition: select adaptation to non-3GPP access |
| 0 | X | X | X | X | X | X | X | Threshold value applicable for RTT measurement |
| 1 | X | X | X | X | X | X | X | Threshold value applicable for PLR measurement |

All other values are spare.
MFI (measurement frequency indicator) (octet c, bit 1) is set as follows:

| | |
|---|---|
| 0 | Measurement frequency is not specified |
| 1 | Measurement frequency is specified |

AFI (adaptation frequency indicator) (octet c, bit 2) is set as follows:

| | |
|---|---|
| 0 | Adaptation frequency is not specified |
| 1 | Adaptation frequency is specified |

If MFI is set to 1, MeasFreq is specified as the frequency with which performance measurement(s) is (are) to be made.
The measurement frequency specifies the period between performance measurements.
If AFI is set to 1, AdaptFreq is specified as the frequency with which traffic steering adaptation is to be made. The
adaptation frequency may be specified as an absolute time or as a time relative to the measurement frequency.

TABLE 19
PMFP MEASUREMENT REQUEST message content

| IEI | | | | | |
|---|---|---|---|---|---|
| [symbol] | Information Element | Type/Reference | Presence | Format | Length |
| | PMFP measurement | Message type | M | V | 1 |
| | request message identity | Table 7 | | | |
| | EPTI | Extended procedure transaction identity | M | V | TBD |
| | | 6.2.2.2 of 3GPP TS 24.193 | | | |
| | Measurement Info | Identifies the measurement for the | M | V | 1 |
| | | associate QFI | | | |
| | | Table 21 | | | |
| | Value for measurement | Value use to compute the | O | V | 1 |
| | | performance measurement | | | |
| | | Table 21 | | | |
| TBD | Padding | Padding | O | TVL-E | 3-1000 |
| | | 6.2.2.6 of 3GPP TS 24.193 | | | |

TABLE 20
PMFP MEASUREMENT RESPONSE message content

| IEI | Information Element | Type/Reference | Presence | Format | Length |
|---|---|---|---|---|---|
| | PMFP measurement | Message type | M | V | 1 |
| | response message identity | Table 7 | | | |
| | EPTI | Extended procedure | M | V | TBD |
| | | transaction identity | | | |
| | | 6.2.2.2 of 3GPP TS 24.193 | | | |
| | Measurement value | Measurement value based on | O | V | 2 |
| | | request | | | |
| | | Table 21 | | | |
| TBD | Padding | Padding | O | TVL-E | 3-1000 |
| | | 6.2.2.6 of 3GPP TS 24.193 | | | |

We claim:

1. A wireless transmit/receive unit (WTRU), comprising a transceiver and one or more processors, configured to:
send a request for a multi-access protocol data unit (MA PDU) session, wherein the request indicates support for a steering capability and one or more steering modes;
receive one or more steering rules comprising an indicator indicating a steering mode, wherein the steering mode is any of autonomous or UE assisted; and
send, based on the received indicator, information indicating one or more percentages for steering traffic for the MA PDU session.

2. The WTRU of claim 1, wherein the information is sent in a performance measurement function (PMF) message.

3. The WTRU of claim 1, wherein the sending the information indicating the one or more percentages for steering traffic for the MA PDU session comprises:
sending, using performance measurement function (PMF) protocol signaling, the information indicating the one or more percentages for steering traffic for the MA PDU session.

4. The WTRU of claim 1, wherein the sending the information indicating the one or more percentages for steering traffic for the MA PDU session comprises:
sending, using user plane signaling, the information indicating the one or more percentages for steering traffic for the MA PDU session.

5. The WTRU of claim 1, wherein the steering capability comprises an adaptive traffic steering capability.

6. The WTRU of claim 1, wherein the one or more steering rules comprise one or more access traffic steering, switching, and splitting (ATSSS) rules.

7. The WTRU of claim 1, wherein steered traffic comprises 3GPP and non-3GPP traffic.

8. A method for use in a wireless transmit/receive unit (WTRU), the method comprising:
sending a request for a multi-access protocol data unit (MA PDU) session, wherein the request indicates support for a steering capability and one or more steering modes;
receiving one or more steering rules comprising an indicator indicating a steering mode, wherein the steering mode is any of autonomous or UE assisted; and
sending, in response to receiving the indicator, information indicating one or more percentages for steering traffic for the MA PDU session.

9. The method of claim 8, wherein the information is sent in a performance measurement function (PMF) message.

10. The method of claim 8, wherein the sending the information indicating the one or more percentages for steering traffic for the MA PDU session comprises:
sending, using performance measurement function (PMF) protocol signaling, the information indicating the one or more percentages for steering traffic for the MA PDU session.

11. The method of claim 8, wherein the sending the information indicating the one or more percentages for steering traffic for the MA PDU session comprises:
sending, using user plane signaling, the information indicating the one or more percentages for steering traffic for the MA PDU session.

12. The method of claim 8, wherein the steering capability comprises an adaptive traffic steering capability.

13. The method of claim 8, wherein the one or more steering rules comprise one or more access traffic steering, switching, and splitting (ATSSS) rules.

14. The method of claim 8, wherein steered traffic comprises 3GPP and non-3GPP traffic.

15. An apparatus, comprising a transceiver and one or more processors, configured to:
receive a request for a multi-access protocol data unit (MA PDU) session, wherein the request indicates support for a steering capability and one or more steering modes;
send one or more steering rules comprising an indicator indicating a steering mode, wherein the steering mode is any of autonomous or UE assisted; and
receive, information indicating one or more percentages for steering traffic for the MA PDU session.

16. The apparatus of claim 15, wherein the information is received in a performance measurement function (PMF) message.

17. The apparatus of claim 15, wherein the receiving the information indicating the one or more percentages for steering traffic for the MA PDU session comprises:
receiving, via performance measurement function (PMF) protocol signaling, the information indicating the one or more percentages for steering traffic for the MA PDU session.

18. The apparatus of claim 15, wherein the steering capability comprises an adaptive traffic steering capability.

19. The apparatus of claim 15, wherein the one or more steering rules comprise one or more access traffic steering, switching, and splitting (ATSSS) rules.

20. The apparatus of claim 15, wherein steered traffic comprises 3GPP and non-3GPP traffic.
